(19) United States
(12) Patent Application Publication
(10) Pub. No.: US 2025/0183718 A1
(43) Pub. Date: Jun. 5, 2025

(54) PLANAR INDUCTION COIL ASSEMBLY AND MULTI-RECEIVING WIRELESS CHARGING DEVICE

(71) Applicant: SPEED TECH CORPORATION, TAOYUAN CITY (TW)

(72) Inventors: Yu-Pei Huang, TAOYUAN CITY (TW); Kuan-Ying Ho, TAOYUAN CITY (TW); Yao-Nien Chung, TAOYUAN CITY (TW); Chih-Yung Wu, TAOYUAN CITY (TW); Ming-Der Liu, TAOYUAN CITY (TW); Chi-Chun Chen, TAOYUAN CITY (TW)

(73) Assignee: SPEED TECH CORPORATION, TAOYUAN CITY (TW)

(21) Appl. No.: 18/429,698

(22) Filed: Feb. 1, 2024

(30) Foreign Application Priority Data
Nov. 30, 2023 (TW) 112146692

(51) Int. Cl. H02J 50/12; H01F 27/28; H02J 7/00; H02J 50/40; H02J 50/80

(52) U.S. Cl. CPC H02J 50/12; H01F 27/28; H02J 7/00712; H02J 50/402; H02J 50/80

(57) ABSTRACT

A planar induction coil assembly includes a first coil, a second coil, and a third coil. The first coil has a first spiral direction from outside to inside. The second coil has a second spiral direction. The first spiral direction is opposite to the second spiral direction. The first coil, the second coil, and the third coil are electrically isolated from each other, and a vertical projection of each of the first coil, the second coil, and the third coil partially overlaps the vertical projection of at least one of the remaining two coils. Furthermore, a multi-receiving wireless charging device includes a first coil, a second coil, and a third coil. The first coil and the second coil have opposite current directions. The first coil and the third coil have a same current direction.

### CROSS-REFERENCE TO RELATED APPLICATION

This non-provisional application claims priority under 35 U.S.C. § 119 (a) to patent application No. 112146692 filed in Taiwan, R.O.C. on Nov. 30, 2023, the entire contents of which are hereby incorporated by reference.

### BACKGROUND

### Technical Field

The present application relates to magnetic resonance (magnetic resonance, MR) wireless charging technologies, and in particular, to a planar induction coil assembly and a multi-receiving wireless charging device.

### Related Art

With the advancement of technology, a charging mode of an electronic product has developed from wired charging to wireless charging. However, there are still some technical problems with the electronic product that uses wireless charging (which is referred to as a wireless charging device below). For example, for an existing wireless charging device, there is still a large area of charging dead zone (that is, a region that cannot be charged) in a wireless charging pad for charge the wireless charging device, so that the wireless charging device needs to be accurately disposed in a specific location in the wireless charging pad to charge. In addition, there is still space for improvement in charging efficiency of the wireless charging device compared with an electronic product that uses wired charging (which is referred to as a wired charging device below).

### SUMMARY

In view of this, the inventor proposed a planar induction coil assembly and a multi-receiving wireless charging device, which can decrease a charging dead zone of a wireless charging pad during charging, thereby improving charging efficiency of the wireless charging device and enhancing convenience of the wireless charging device.

In some embodiments, a planar induction coil assembly includes a first coil, a second coil, and a third coil. The first coil has a first spiral direction from outside to inside. The second coil has a second spiral direction. The first coil, the second coil, and the third coil are electrically isolated from each other, and a vertical projection of each of the first coil, the second coil, and the third coil partially overlaps the vertical projection of at least one of the remaining two coils.

In some embodiments, a contour of each coil has a first arc, and the first arc of the contour of the first coil, the first arc of the contour of the second coil, and the first arc of the contour of the third coil together form an oblate, an oval, or a circular outer contour having an area larger than the contour of each coil.

In some embodiments, the first coil, the second coil, and the third coil each have the oblate contour.

In some embodiments, the first coil is symmetrically arranged with the second coil, and the first coil is rotated by 60 degrees relative to the third coil.

In some embodiments, the planar induction coil assembly further includes a multi-layer insulating substrate. The first coil, the second coil, and the third coil are arranged on the multi-layer insulating substrate, and the first coil and the second coil are located on different layers of the multi-layer insulating substrate.

In some embodiments, the multi-layer insulating substrate includes three surfaces isolated from each other by an insulating substrate, and the first coil, the second coil, and the third coil are respectively located on the three surfaces.

In some embodiments, the third coil includes a first line segment group, a second line segment group, and a plurality of pilot holes. The first line segment group is located on a same layer of the multi-layer insulating substrate as the first coil and electrically isolated from the first coil. The second line segment group is located on a same layer of the multi-layer insulating substrate as the second coil and electrically isolated from the second coil. The plurality of pilot holes penetrate at least one layer of the multi-layer insulating substrate and electrically connected to the first line segment group and the second line segment group.

In some embodiments, the planar induction coil assembly further includes a fourth coil. The fourth coil is electrically isolated from the first coil, the second coil, and the third coil. A vertical projection of each of the first coil, the second coil, the third coil, and the fourth coil partially overlaps the vertical projections of at least two of the remaining three coils.

In some embodiments, a contour of each coil includes a first arc and a second arc, and the first arc of the contour of the first coil, the first arc of the contour of the second coil, the first arc of the contour of the third coil, and the first arc of the contour of the fourth coil together form an oblate, an oval, or a circular outer contour having an area larger than the contour of each coil.

In some embodiments, a multi-receiving wireless charging device includes a first coil, a second coil, and a third coil. The first coil and the second coil have opposite current directions. The first coil, the second coil, and the third coil are electrically isolated from each other, and vertical projections of the first coil, the second coil, and the third coil partially overlap.

In some embodiments, the multi-receiving wireless charging device further includes a plurality of energy conversion circuits, a voltage regulator circuit, a plurality of control circuits, and a plurality of notification circuits. The energy conversion circuits are electrically connected to the first coil, the second coil, and the third coil in one-to-one correspondence to receive a wireless power signal to convert the wireless power signal into a direct current power supply. The voltage regulator circuit is electrically connected to the plurality of energy conversion circuits to generate an output voltage based on the direct current power supply. The plurality of control circuits are electrically connected to the voltage regulator circuit to generate a notification signal based on the output voltage and a voltage threshold. The plurality of notification circuits are electrically connected to the control circuits, where each notification circuit is electrically connected to at least one of the first coil, the second coil, and the third coil to wirelessly output the notification signal via the electrically connected coil. The first coil and the second coil are electrically connected to different notification circuits.

In some embodiments, the wireless power signal is generated by a wireless power supply circuit, and the wireless power supply circuit is further configured to receive the notification signal to increase power of the wireless power signal. The wireless power supply circuit has at least one transmitting coil, and a distance of a line connecting any two centers of the first coil, the second coil, and the third coil is greater than a wound line distance of each transmitting coil.

In some embodiments, an overlapping region of the first coil, the second coil, and the third coil includes hollow regions.

In some embodiments, the first coil, the second coil, and the third coil together form a circular or an oblate outer contour having an area larger than each coil.

In some embodiments, the multi-receiving wireless charging device further includes a fourth coil. The first coil, the second coil, the third coil, and the fourth coil are electrically isolated from each other, and vertical projections of the first coil, the second coil, the third coil, and the fourth coil partially overlap.

In some embodiments, the multi-receiving wireless charging device further includes a multi-layer insulating substrate. The multi-layer insulating substrate includes four surfaces isolated from each other by an insulating substrate, and the first coil, the second coil, the third coil, and the fourth coil are respectively located on the four surfaces.

In some embodiments, an overlapping region of the first coil, the second coil, the third coil, and the fourth coil includes hollow regions.

In some embodiments, the first coil, the second coil, the third coil, and the fourth coil together form a circular or an oblate outer contour having an area larger than each coil.

In summary, according to any embodiment, the planar induction coil assembly or the multi-receiving wireless charging device is applied to a load device. This can ensure that the load device can be charged when at least one of a plurality of coils located on the wireless power supply circuit does not fall into the charging dead zone. In some embodiments, the multi-receiving wireless charging device can also notify, when the output voltage generated by the multi-receiving wireless charging device is insufficient, the wireless power supply circuit via at least one coil to increase power of the wireless power signal generated by the wireless power supply circuit, to increase the output voltage generated by the multi-receiving wireless charging device, thereby improving charging efficiency of the multi-receiving wireless charging device.

### BRIEF DESCRIPTION OF THE DRAWINGS

FIG. 1 is a three-dimensional schematic diagram of a first angle of view of a planar induction coil assembly according to a first embodiment;

FIG. 2 is a three-dimensional schematic diagram of a second angle of view of the planar induction coil assembly in FIG. 1;

FIG. 3 is a three-dimensional schematic diagram of a third angle of view of the planar induction coil assembly in FIG. 1;

FIG. 4 is a schematic top view planar diagram of the planar induction coil assembly in FIG. 1;

FIG. 5 is a schematic bottom view planar diagram of the planar induction coil assembly in FIG. 1;

FIG. 6 is a schematic front view planar diagram of the planar induction coil assembly in FIG. 1;

FIG. 7 is a schematic top view planar diagram of a multi-layer insulating substrate of the planar induction coil assembly in FIG. 1;

FIG. 8 is a schematic front view planar diagram of a multi-layer insulating substrate of the planar induction coil assembly in FIG. 1;

FIG. 9 is a local three-dimensional exploded view of a multi-layer insulating substrate of the planar induction coil assembly in FIG. 1;

FIG. 10 is a three-dimensional schematic diagram of a planar induction coil assembly according to a third embodiment;

FIG. 11 is a schematic top view planar diagram of a multi-layer insulating substrate of the planar induction coil assembly in FIG. 10;

FIG. 12 is a schematic front view planar diagram of a multi-layer insulating substrate of the planar induction coil assembly in FIG. 10;

FIG. 13 is a local three-dimensional exploded view of a multi-layer insulating substrate of the planar induction coil assembly in FIG. 10;

FIG. 14 is a three-dimensional schematic diagram of a planar induction coil assembly according to a fourth embodiment;

FIG. 15 is a schematic top view planar diagram of the planar induction coil assembly in FIG. 14;

FIG. 16 is a schematic bottom view planar diagram of the planar induction coil assembly in FIG. 14;

FIG. 17 is a schematic front view planar diagram of a multi-layer insulating substrate of the planar induction coil assembly in FIG. 14;

FIG. 18 is a local three-dimensional exploded view of a multi-layer insulating substrate of the planar induction coil assembly in FIG. 14;

FIG. 19 is a modular block diagram of a multi-receiving wireless charging device according to an embodiment;

FIG. 20 is a modular block diagram of the multi-receiving wireless charging device in FIG. 19 according to a first embodiment;

FIG. 21 is a modular block diagram of the multi-receiving wireless charging device in FIG. 19 according to a second embodiment;

FIG. 22 is an operational flow chart of the multi-receiving wireless charging device in FIG. 20 according to an embodiment;

FIG. 23 is a planar perspective of a demonstration pattern of the multi-receiving wireless charging device in FIG. 20;

FIG. 24 is a planar perspective of a demonstration pattern of the multi-receiving wireless charging device in FIG. 20 during charging;

FIG. 25 is a three-dimensional schematic diagram of a planar induction coil assembly according to a fifth embodiment;

FIG. 26 is a schematic top view planar diagram of a multi-layer insulating substrate of the planar induction coil assembly in FIG. 25;

FIG. 27 is a schematic front view planar diagram of a multi-layer insulating substrate of the planar induction coil assembly in FIG. 25;

FIG. 28 is a local three-dimensional exploded view of a multi-layer insulating substrate of the planar induction coil assembly in FIG. 25;

FIG. 29 is a three-dimensional schematic diagram of a planar induction coil assembly according to a sixth embodiment;

FIG. 30 is a schematic top view planar diagram of a multi-layer insulating substrate of the planar induction coil assembly in FIG. 29;

FIG. 31 is a schematic front view planar diagram of a multi-layer insulating substrate of the planar induction coil assembly in FIG. 29; and

FIG. 32 is a local three-dimensional exploded view of a multi-layer insulating substrate of the planar induction coil assembly in FIG. 29.

### DETAILED DESCRIPTION

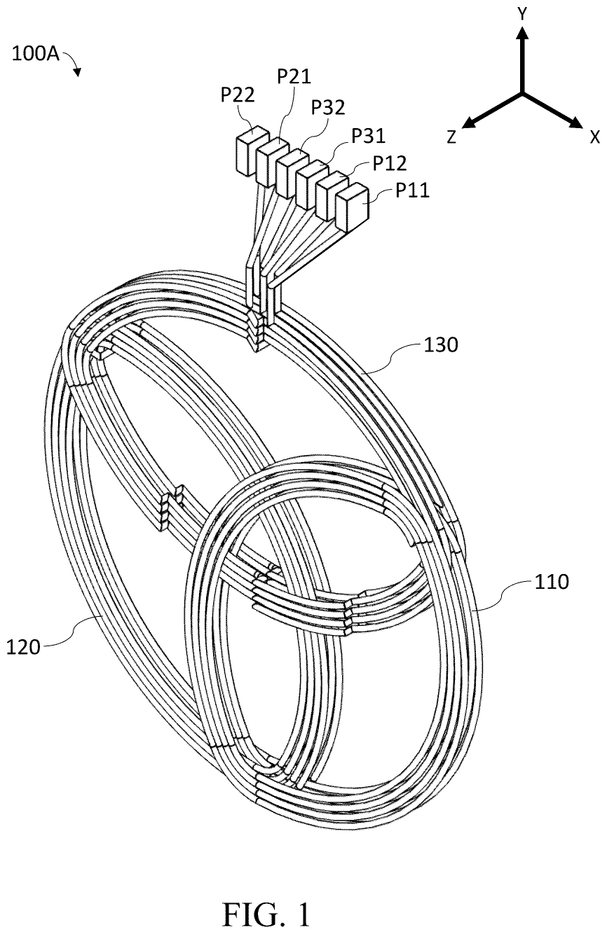

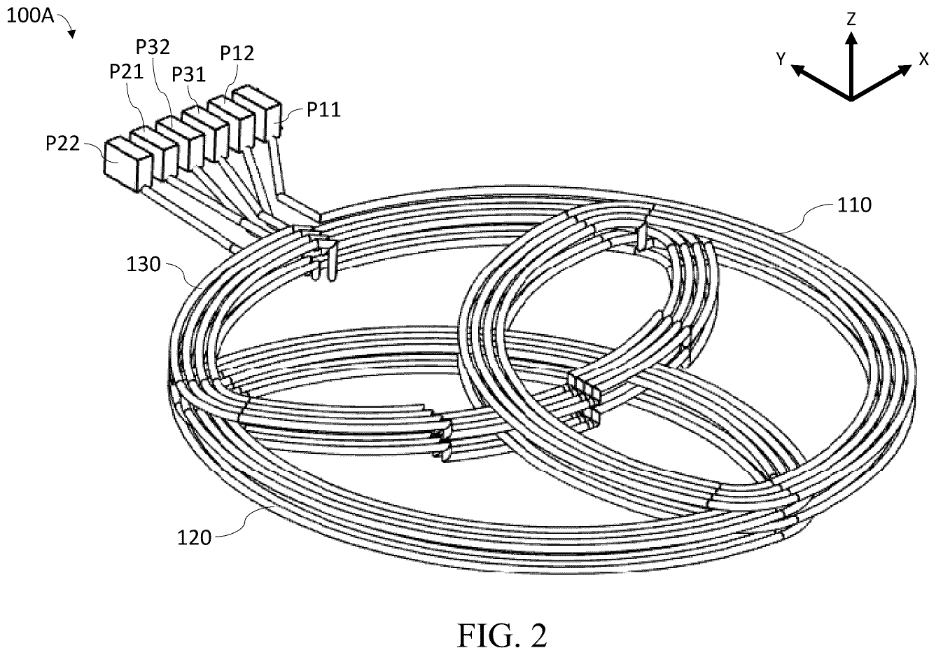

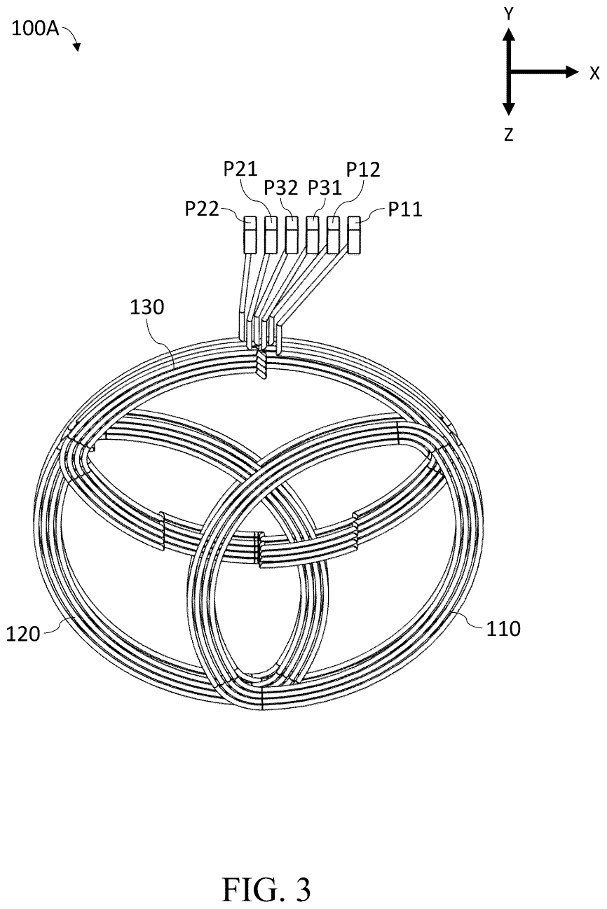

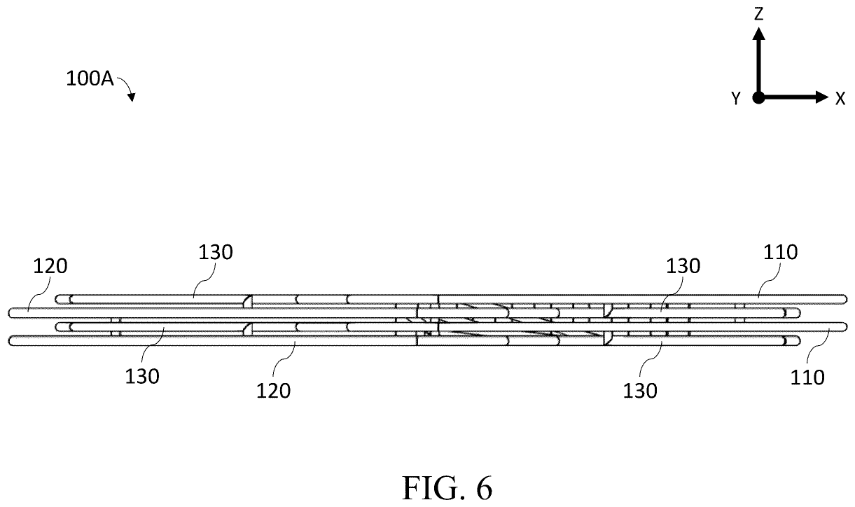

Refer to FIG. 1 to FIG. 6. A planar induction coil assembly 100A includes at least three coils 110, 120, and 130. The following uses the three coils 110, 120, and 130 as examples. For ease of description, the three coils 110, 120, and 130 are respectively referred to as a first coil 110, a second coil 120, and a third coil 130 below.

The first coil 110 has a spiral direction (which is referred to as a first spiral direction below) from outside to inside. Specifically, the first coil 110 includes two pins P11 and P12, two connection segments (which are referred to as a first connection segment and a second connection segment below), and a spiral segment (which is referred to as a first spiral segment below). A first end of the first spiral segment is connected to the pin P11 via the first connection segment, and a second end of the first spiral segment is connected to the pin P12 via the second connection segment. The first spiral direction refers to a direction starting from the first end of the first spiral segment to the second end of the first spiral segment and spiraling from outside to inside.

The second coil 120 has a spiral direction (which is referred to as a second spiral direction below) from inside to outside. Specifically, the second coil 120 includes two pins P21 and P22, two connection segments (which are referred to as a third connection segment and a fourth connection segment below), and a spiral segment (which is referred to as a second spiral segment below). A first end of the second spiral segment is connected to the pin P21 via the third connection segment, and a second end of the second spiral segment is connected to the pin P22 via the fourth connection segment. The second spiral direction refers to a direction starting from the first end of the second spiral segment to the second end of the second spiral segment and spiraling from inside to outside.

Therefore, the first spiral direction is opposite to the second spiral direction. In some embodiments, a spiral direction of the third coil 130 (that is, a third spiral direction) may be the same as that of the first coil 110, or may be the same as that of the second coil 120. In other words, at least one of the first spiral direction, second spiral direction, and third spiral direction is different from the remaining two spiral directions.

Using the planar induction coil assembly 100A shown in FIG. 1 to FIG. 6 as an example, the third coil 130 has a spiral direction (which is referred to as the third spiral direction below) from outside to inside. Specifically, the third coil 130 includes two pins P31 and P32, two connection segments (which are referred to as a fifth connection segment and a sixth connection segment below), and a spiral segment (which is referred to as a third spiral segment below). A first end of the third spiral segment is connected to the pin P31 via the fifth connection segment, and a second end of the third spiral segment is connected to the pin P32 via the sixth connection segment. The third spiral direction refers to a direction starting from the first end of the third spiral segment to the second end of the third spiral segment and spiraling from outside to inside. In other words, the third spiral direction of the third coil 130 is also clockwise as the first spiral direction of the first coil 110, while the second spiral direction of the second coil 120 is opposite to the first spiral direction of the first coil 110 (that is, the second spiral direction is counterclockwise).

In some embodiments, the coils 110/120/130 may be multi-turn spiral windings. In some other embodiments, the coils 110/120/130 may be single-turn circular windings. Therefore, in some embodiments, the first coil 110, the second coil 120, and the third coil 130 are all the multi-turn spiral windings.

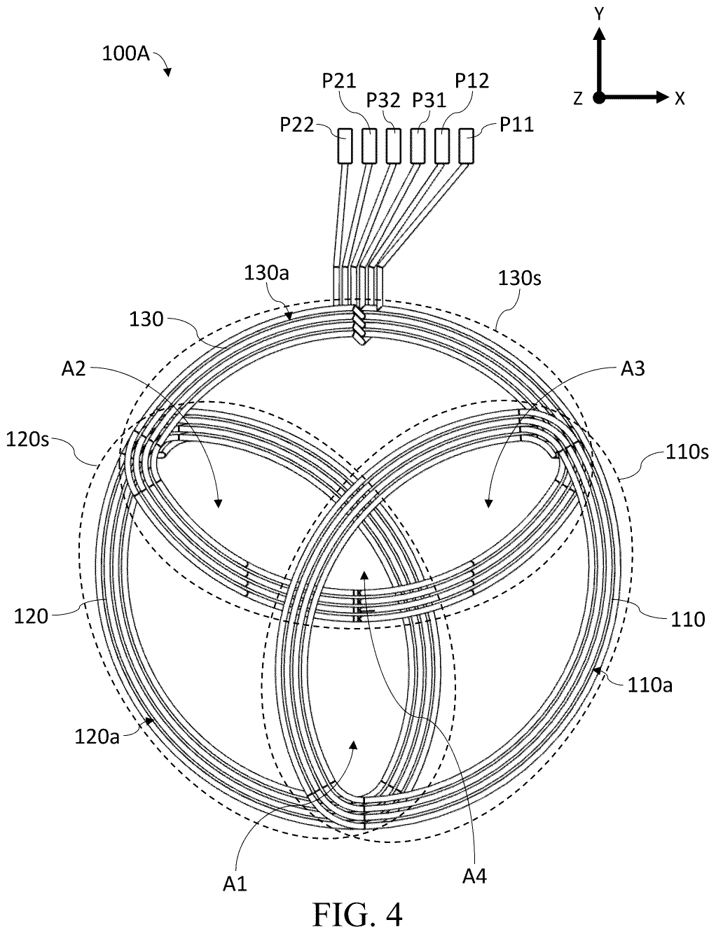

The first coil 110, the second coil 120, and the third coil 130 are electrically isolated from each other, and a vertical projection of each of the first coil 110, the second coil 120, and the third coil 130 partially overlaps the vertical projection of at least one of the remaining two coils (as shown in FIG. 4). In other words, in a ZY direction, the first coil 110, the second coil 120, and the third coil 130 have some overlapping line segments, but are not electrically connected to each other and not conductive.

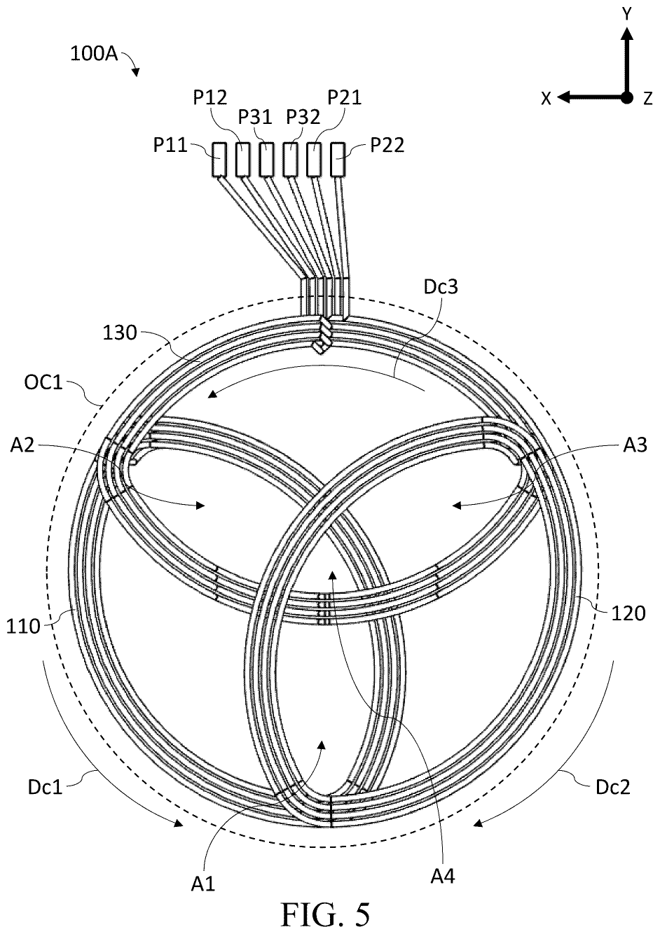

In some embodiments, contours (that are, contours of the outermost rings of the spiral segments) of the coils 110/120/130 in the planar induction coil assembly 100A each have an arc 110a/120a/130a (which is referred to as a first arc 110a/120a/130a below). The first arcs of all coils 110a, 120a, and 130a together form an oblate, an oval, or a circular outer contour OC1 having an area larger than the contour of each coil. Refer to FIG. 4 and FIG. 5. For example, the first arc 110a of the contour 110s of the first coil 110 (which is referred to as a first contour 110s below), the first arc 120a of the contour 120s of the second coil 120 (which is referred to as a second contour 120s below), and the first arc 130a of the contour 130s of the third coil 130 (which is referred to as a third contour 130s below) together form a circular outer contour OC1 (as shown in FIG. 5). An area of the circle is larger than an area of each contour 110s/120s/130s of each coil 110/120/130. Specifically, the planar induction coil assembly 100A that mainly includes three coils 110, 120, and 130 is used as an example. The area of the outer contour OC1 is larger than the area of the first contour 110s, is also larger than the area of the second contour 120s, and is also larger than the area of the third contour 130s.

Refer to FIG. 4 and FIG. 5. In some embodiments, the coils 110/120/130 in the planar induction coil assembly 100A each have an oblate contour 110s/120s/130s. As shown in FIG. 4 and FIG. 5, specifically, the contours 110s/120s/130s of the coils 110/120/130 each have not only the first arc 110a/120a/130a, but also another arc (which is referred to as a second arc). In other words, a shape of the outermost ring of the spiral segment of each coil in the planar induction coil assembly 100A is oblate, and the shape is formed by the first arc and the second arc.

In some embodiments, a quantity of coils of the planar induction coil assembly 100A may be three or four. In some embodiments, when the quantity of coils of the planar induction coil assembly 100A is three (that is, the first coil 110, the second coil 120, and the third coil 130), the first coil 110 and the second coil 120 having opposite spiral directions may be symmetrically arranged (that is, the spiral segments are symmetrical). The first coil 110 and the third coil 130 having a same spiral direction are rotated relative to each other by 60 degrees.

In some embodiments, for a same coil 110/120/130, all turns of the spiral segment are distributed in a same plane. In some other embodiments, for a same coil 110/120/130, a same turn of the spiral segment is distributed in a same plane, but the remaining different turns of the spiral segment may be distributed in different planes. Turns on different planes are electrically connected via pilot holes. In some other embodiments, for a same coil 110/120/130, approximately same segments of a spiral segment are distributed in a same plane. Specifically, for a same coil 110/120/130, turns of the spiral segment are formed by staggering and sequentially connecting to a plurality of planar line segments and at least one pilot hole. A same turn of a plurality of planar line segments are distributed on a plurality of planes, and approximately same segments refer to adjacent planar line segments distributed in a same direction among all the turns.

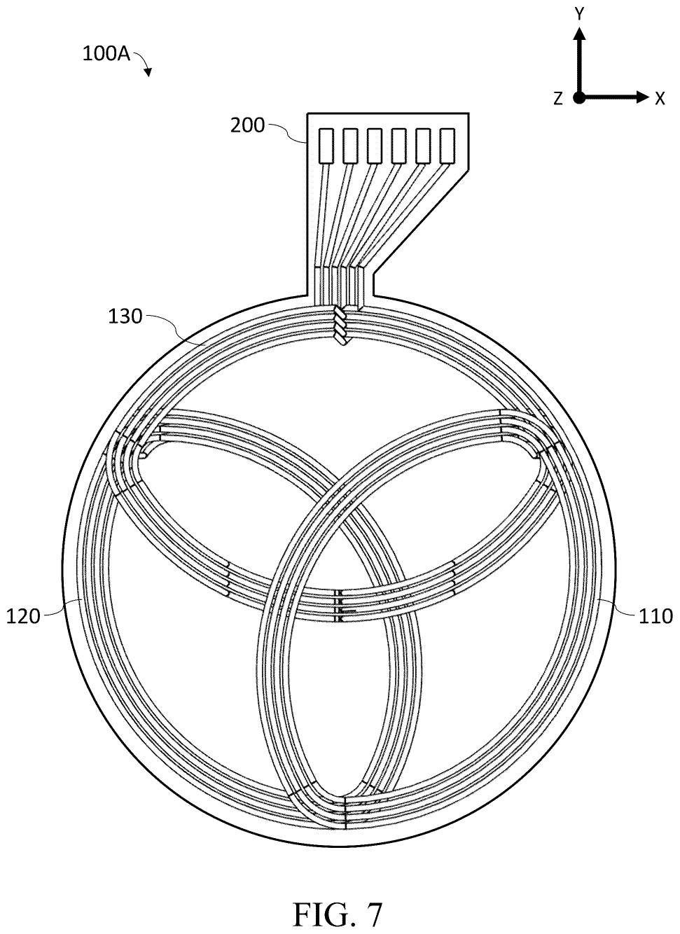

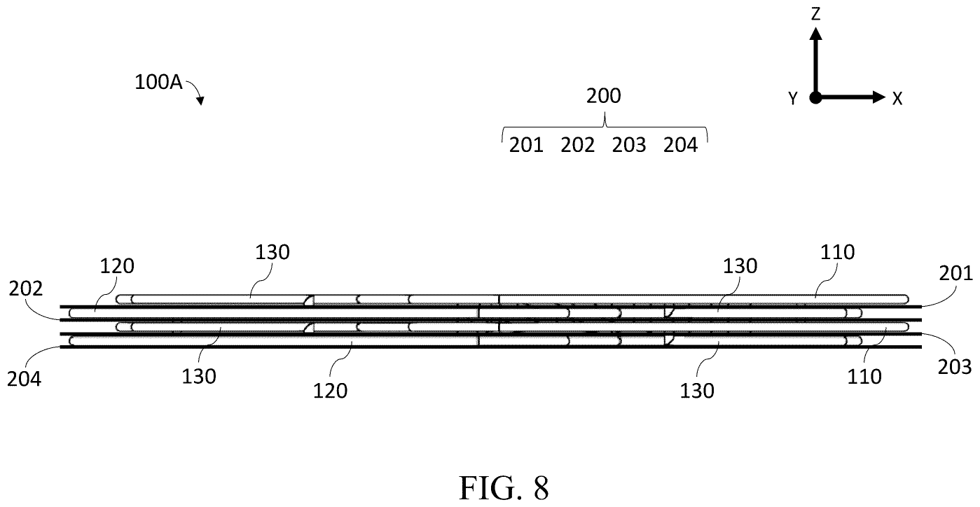

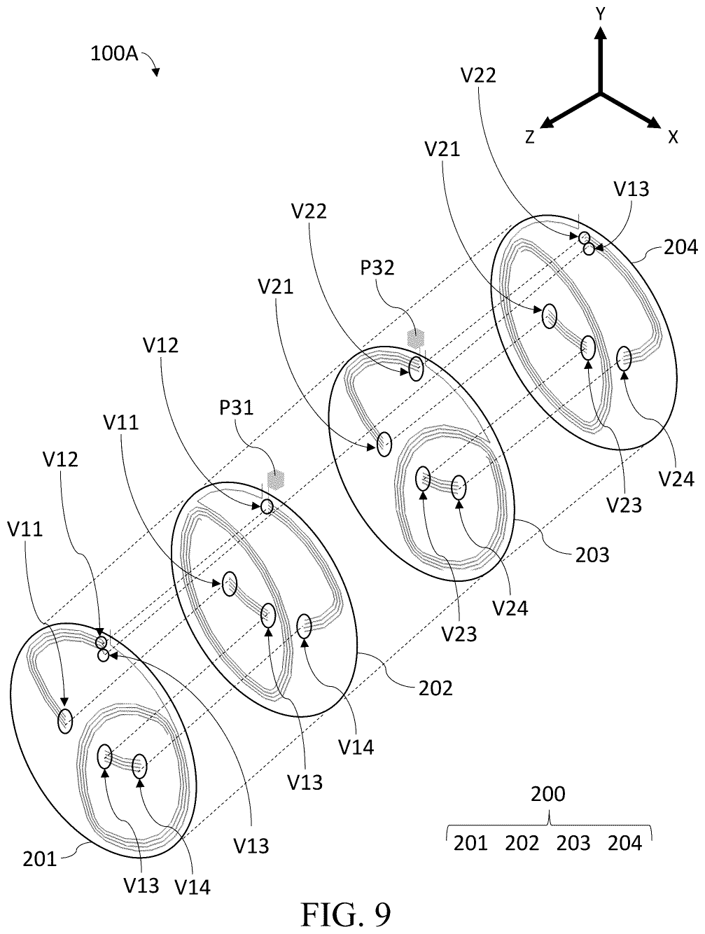

Refer to FIG. 7 to FIG. 9. In some embodiments, the planar induction coil assembly 100A further includes a multi-layer insulating substrate 200. A first coil 110, a second coil 120, and the third coil 130 are arranged on the multi-layer insulating substrate 200, and the first coil 110 and the second coil 120 are located on different layers (insulating layers) of the multi-layer insulating substrate 200. As shown in FIG. 8 and FIG. 9, in some embodiments, the multi-layer insulating substrate 200 includes a plurality of insulating layers 201 to 204 stacked sequentially. The first coil 110 is located on the first insulating layer 201 and the third insulating layer 203 in the multi-layer insulating substrate 200. The second coil 120 is located on the second insulating layer 202 and the fourth insulating layer 204 in the multi-layer insulating substrate 200. The third coil 130 is located on the insulating layers of 201 to 204 in the multi-layer insulating substrate 200. In other words, a plurality of turns of the first coil 110 are located on different insulating layers 201 and 203, but a same turn of line segment is located on a same insulating layer 201/203. Similarly, a plurality of turns of the second coil 120 are located on different insulating layers 202 and 204, but a same turn of line segment is located on the same insulating layer 201/203. A plurality of turns of the third coil 130 are distributed on the plurality of insulating layers 201 to 204 where the first coil 110 and the second coil 120 are located, and a same turn of line segment is distributed on two adjacent insulating layers 201 and 202/203 and 204.

Specifically, a first line segment group of the third coil 130 is located on the same insulating layer 201/203 of the multi-layer insulating substrate 200 as the first coil 110 and is electrically isolated from the first coil 110. A second line segment group of the third coil 130 is located on the same insulating layer 202/204 of the multi-layer insulating substrate 200 as the second coil 120 and is electrically isolated from the second coil 120.

In some embodiments, a plurality of pilot holes V11 to V14 and V21 to V24 penetrate at least one layer (an insulating layer) of the multi-layer insulating substrate 200 and are electrically connected to the first line segment group and the second line segment group. Using FIG. 9 as an example, the first line segment group in the insulating layer 201 is electrically connected to the second line segment group in the insulating layer 202 via the pilot holes V11 to V14 to form a part of turns of the third coil 130. The first line segment group in the insulating layer 203 is electrically connected to the second line segment group in the insulating layer 204 via the pilot holes V21 to V24 to form the other part of turns of the third coil 130.

It should be noted that, in some embodiments, the first line segment group in the insulating layer 201 is alternatively electrically connected to the second line segment group in the insulating layer 204 via the pilot hole V13 to form the third coil 130 having a plurality of turns in series. Refer to FIG. 9. For example, it is assumed that the third coil 130 is a spiral winding having eight turns. The four-turn spiral winding is located on the insulating layers 201 and 202, and the remaining four-turn spiral winding is located on the insulating layers 203 and 204. In addition, the four-turn spiral winding on the insulating layers 201 and 202 is electrically connected to the four-turn spiral winding on the insulating layers 203 and 204 via the pilot holes V13, so that all the windings (turns) on the third coil 130 are electrically connected between two pins P31 and P32.

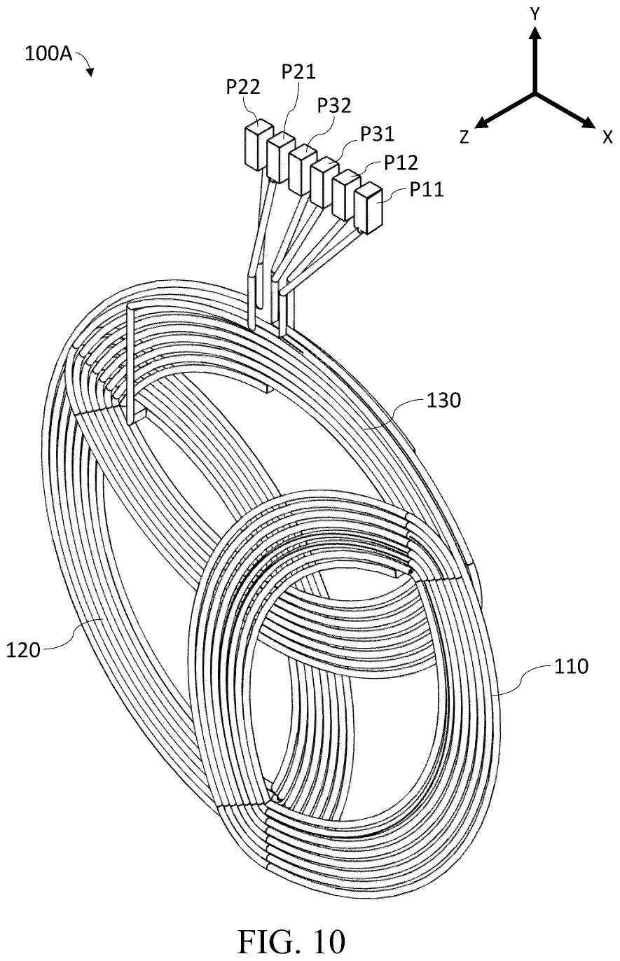

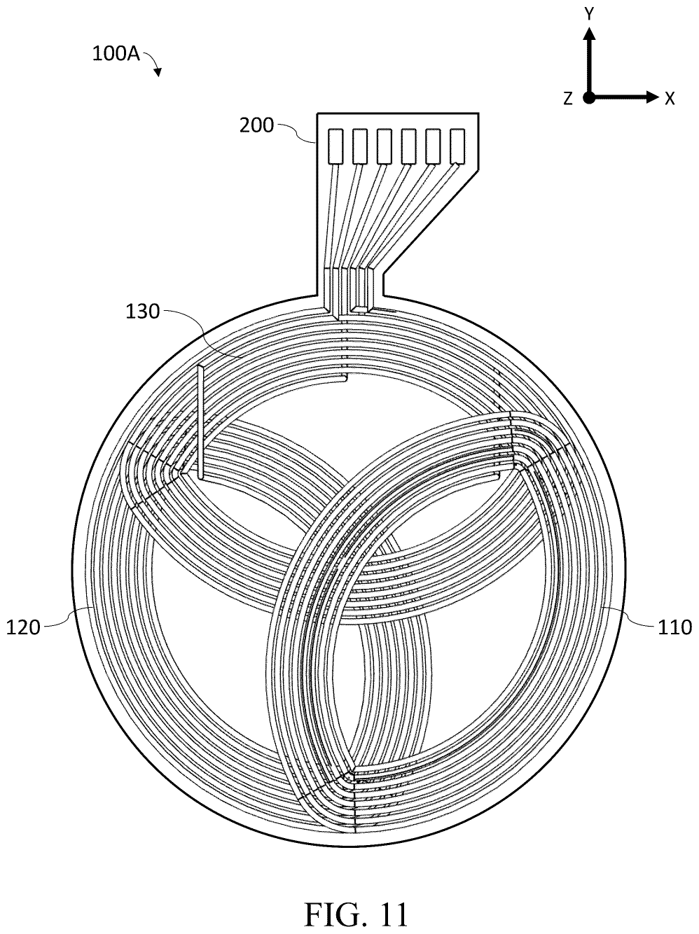

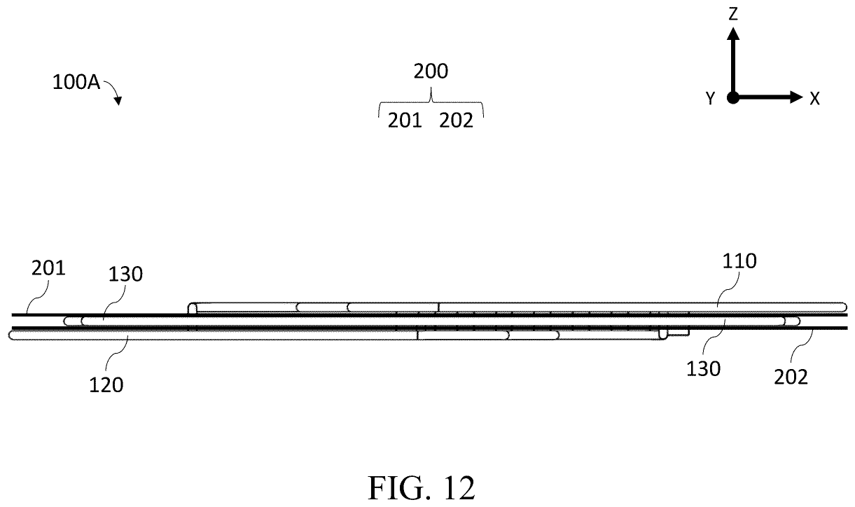

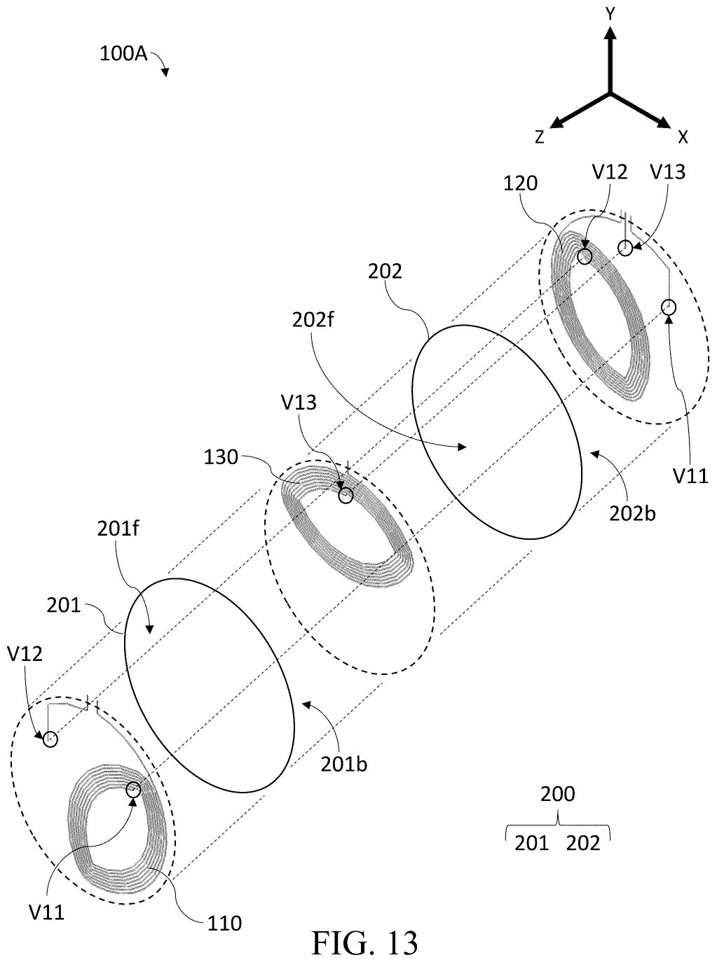

Refer to FIG. 10 to FIG. 13. In some embodiments, the multi-layer insulating substrate 200 includes three surfaces 201f, 201b, and 202b isolated from each other by an insulating substrate, and the first coil 110, the second coil 120, and the third coil 130 are respectively located on the three surfaces 201f, 201b, and 202b. In other words, the multi-layer insulating substrate 200 includes at least two insulating layers 201 and 202 stacked sequentially. A spiral winding of each coil 110/120/130 is located on a same surface 201f/201b/202b in the multi-layer insulating substrate 200. Using FIG. 12 and FIG. 13 as examples, the multi-layer insulating substrate 200 includes two insulating layers 201 and 202, and the coils 110/120/130 are spiral windings having eight turns. The eight-turn spiral winding in the first coil 110 is located on a front surface 201f of the insulating layer 201. The eight-turn spiral winding in the second coil 120 is located on a back surface 202b of the insulating layer 202. The eight-turn spiral winding in the third coil 130 is located on a back surface 201b of the insulating layer 201 (that is, a front surface 202f of the insulating layer 202). In some other embodiments, the multi-layer insulating substrate 200 may alternatively include three insulating layers. The plurality of coils 110, 120, and 130 are respectively located on front surfaces of different insulating layers (not shown) or on back surfaces of different insulating layers (not shown).

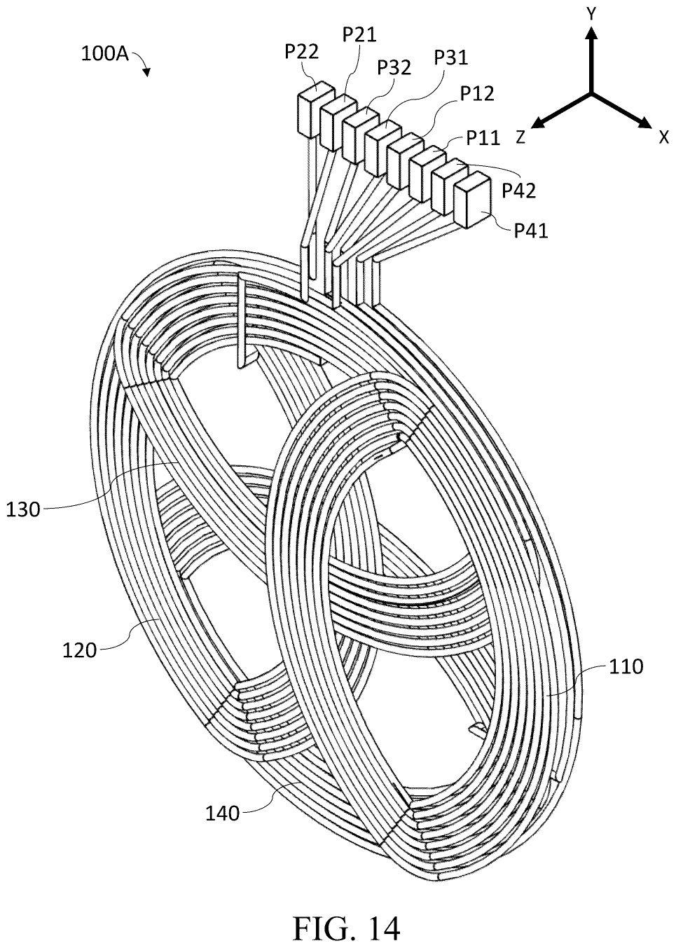

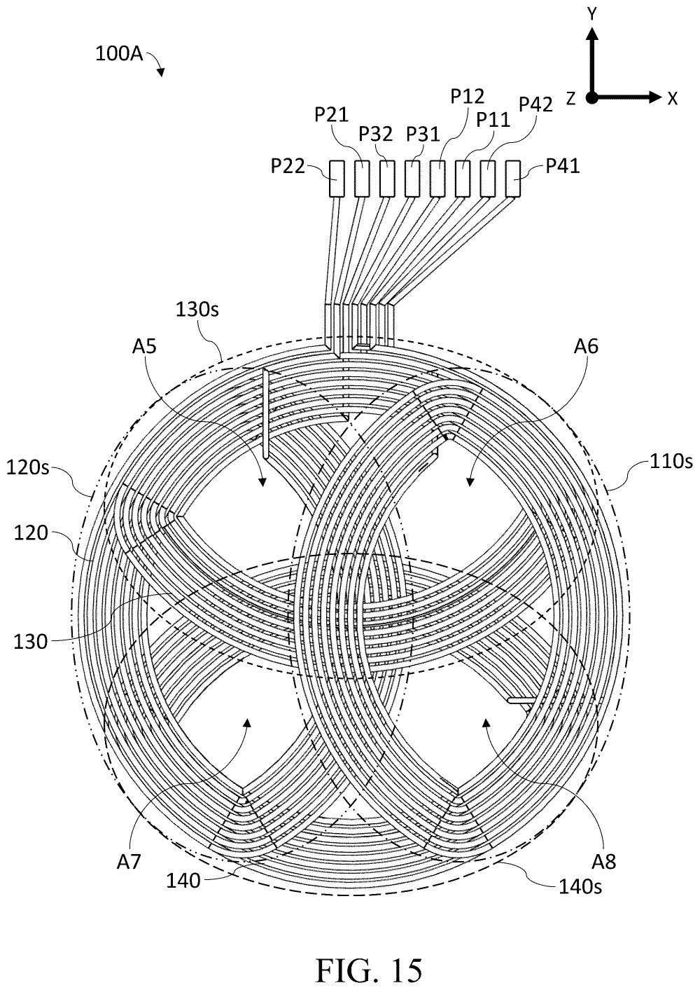

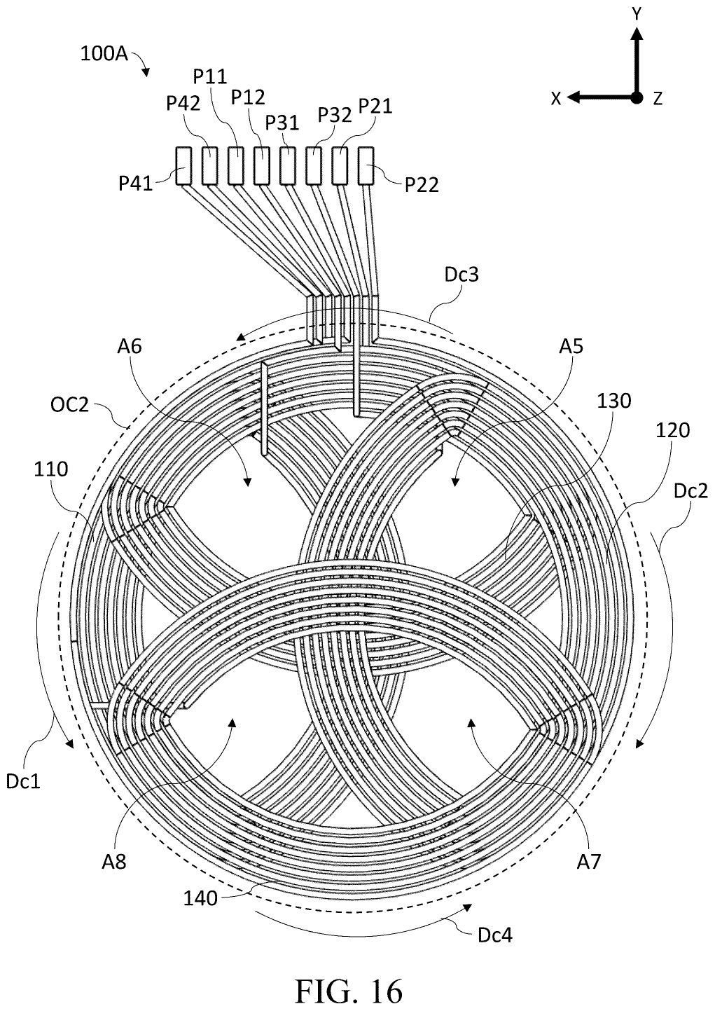

Refer to FIG. 14 to FIG. 18. In some embodiments, the planar induction coil assembly 100A further includes a fourth coil 140. The fourth coil 140 is electrically isolated from the first coil 110, the second coil 120, and the third coil 130, and a vertical projection of each of the first coil 110, the second coil 120, the third coil 130, and the fourth coil 140 partially overlaps the vertical projections of at least two of the remaining three coils (as shown in FIG. 15). In some embodiments, a spiral direction of the fourth coil 140 (that is, a fourth spiral direction) may be the same as that of the first coil 110, or may be the same as that of the second coil 120. Using FIG. 15 and FIG. 16 as examples, the fourth coil 140 has the fourth spiral direction from outside to inside that is the same as the first spiral direction (starting from a pin P41 of the fourth coil 140 to a pin P42 of the fourth coil 140 and spiraling from outside to inside). In other words, at least one coil 120 in the plurality of coils 110 to 140 of the planar induction coil assembly 100A has a different spiral direction from the other coils 110, 130, 140, and the spiral directions of the other coils 110, 130, and 140 are the same as each other.

In some embodiments, a contour of each coil 110/120/130/140 in the planar induction coil assembly 100A includes a first arc and a second arc, and the first arc of the contour of the first coil 110, the first arc of the contour of the second coil 120, the first arc of the contour of the third coil 130, and the first arc of the contour of the fourth coil 140 together form an oblate, an oval, or a circular outer contour OC2 having an area larger than the contour of each coil. Using FIG. 15 and FIG. 16 as examples, a first arc of a first contour 110s, a first arc of a second contour 120s, a first arc of a third contour 130s, and a first arc of a contour 140s of a fourth coil 140 together form a circular outer contour OC2. An area of the outer contour OC2 is larger than the area of each contour 110s/120s/130s/140s of each coil.

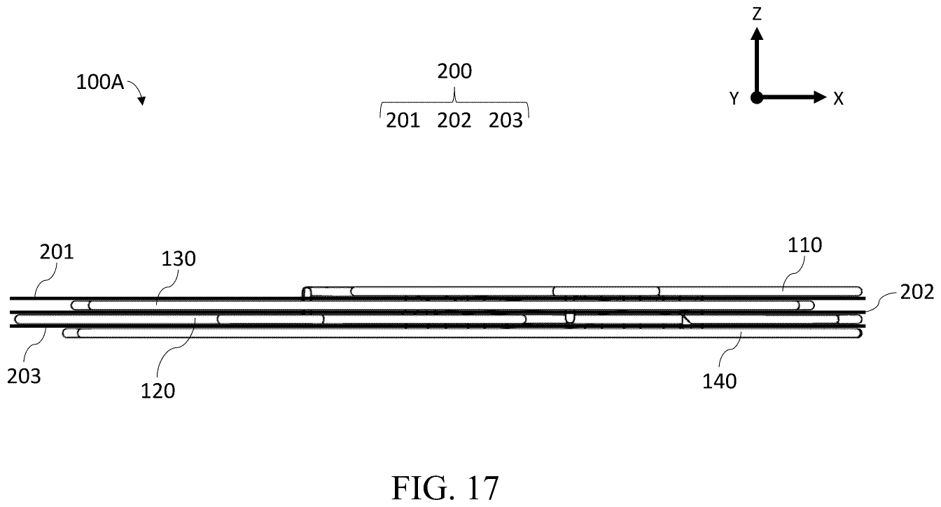

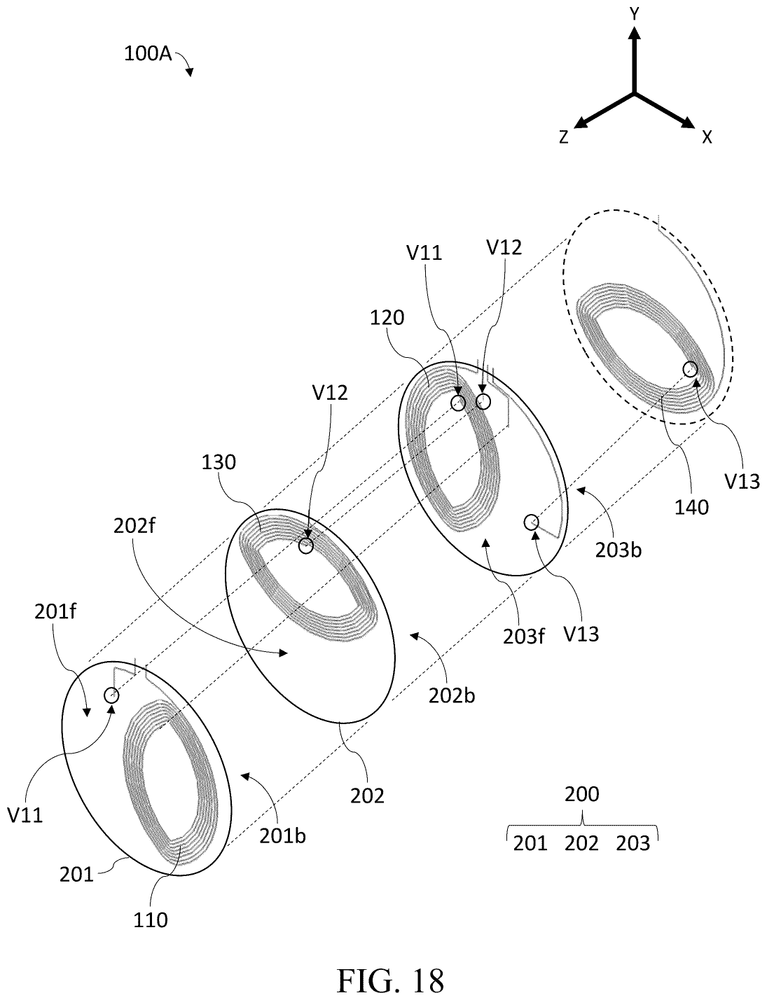

In some embodiments, an example in which the planar induction coil assembly 100A includes four coils 110 to 140 is used. The multi-layer insulating substrate 200 includes four surfaces isolated from each other by an insulating substrate. The four coils 110 to 140 are respectively located on the four surfaces. In other words, the multi-layer insulating substrate 200 includes at least three insulating layers. The four coils 110 to 140 are respectively located at any four of an upper surface of an uppermost layer of the insulating layers, positions between adjacent two insulating layers, and a lower surface of a lowest layer of the insulating layers. A spiral winding of the same coil 110/120/130/140 is located on a same surface of the multi-layer insulating substrate 200. Using FIG. 17 and FIG. 18 as examples, the multi-layer insulating substrate 200 includes three insulating layers 201 to 203, and the coils 110/120/130/140 are spiral windings having eight turns. The eight-turn spiral winding in the first coil 110 is located on a front surface 201f (that is, an upper surface of an uppermost layer) of the insulating layer 201. The eight-turn spiral winding in the second coil 120 is located on a front surface 203f (that is, a back surface 202b of the insulating layer 202) of the insulating layer 203. The eight-turn spiral winding in the third coil 130 is located on a front surface 202f (that is, a back surface 201b of the insulating layer 201) of the insulating layer 202. The eight-turn spiral winding in the fourth coil 140 is located on a back surface 203b (that is, a lower surface of a lowest layer) of the insulating layer 203. In some other embodiments, the multi-layer insulating substrate 200 may alternatively have four insulating layers. The four coils are respectively located on front surfaces of the four insulating layers (not shown) or on back surfaces of the four insulating layers (not shown).

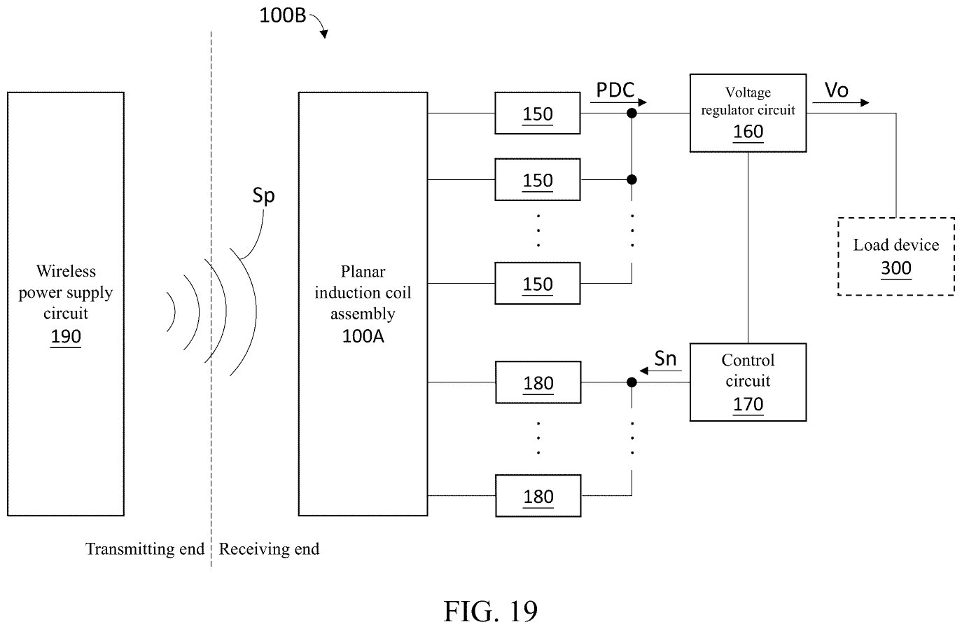

Refer to FIG. 19. In some embodiments, the planar induction coil assembly 100A of any one of the foregoing embodiments may be applied to a multi-receiving wireless charging device 100B, as shown in FIG. 19. In other words, the multi-receiving wireless charging device 100B includes at least the planar induction coil assembly 100A in any one of the foregoing embodiments. For example, the multi-receiving wireless charging device 100B may be a receiving end, and the planar induction coil assembly 100A may be used as an induction coil of the receiving end.

In some embodiments, an example in which the planar induction coil assembly 100A includes three coils 110 to 130 is used. The multi-receiving wireless charging device 100B may include the three coils 110 to 130. Refer to FIG. 1 to FIG. 6 and FIG. 20. The coils 110 to 130 have approximately same contours. The first coil 110 is symmetrically arranged with the second coil 120, and the first coil 110 is rotated by 60 degrees relative to the third coil 130. When the multi-receiving wireless charging device 100B operates, a current enters from a pin P11/P21/P31 of each coil 110/120/130 and flows to the other pin P12/P22/P32. In this case, the first coil 110 has a current direction (which is referred to as a first current direction Dc1 below). The second coil 120 has a current direction opposite to the first current direction Dc1 (which is referred to as a second current direction Dc2 below). The third coil 130 has a same current direction as the first current direction Dc1 (which is referred to as a third current direction Dc3 below). For example, the first current direction Dc1 is clockwise, the second current direction Dc2 is counterclockwise, and the third current direction Dc3 is clockwise.

In some other embodiments, the third coil 130 may alternatively be designed to have the third current direction Dc3 opposite to the first current direction Dc1. In other words, at least one of the first current direction Dc1, the second current direction Dc2, and the third current direction Dc3 is different from the remaining current directions.

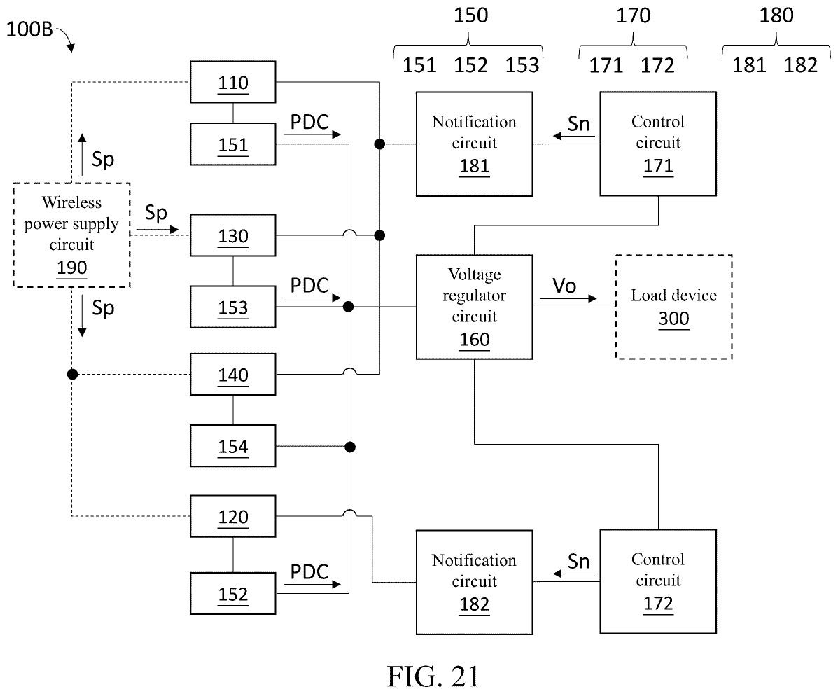

In some embodiments, an example in which the planar induction coil assembly 100A includes four coils 110 to 130 is used. Refer to FIG. 14 to FIG. 21. In some embodiments, the receiving end of the multi-receiving wireless charging device 100B may include the four coils 110 to 140. The coils 110 to 140 have approximately same contours. The first coil 110 is symmetrically arranged with the second coil 120. The first coil 110 is rotated by 90 degrees relative to the third coil 130. The first coil 110 is rotated by −90 degrees relative to the fourth coil 140. In this case, when the multi-receiving wireless charging device 100B operates, the first current direction Dc1 of the first coil 110 is opposite to the second current direction Dc2 of the second coil 120, but is the same as the third current direction Dc3 of the third coil 130. The fourth coil 140 has a current direction (which is referred to as a fourth current direction Dc4 below), and the fourth current direction Dc4 is the same as the first current direction Dc1. For example, the first current direction Dc1 is clockwise, the second current direction Dc2 is counterclockwise, the third current direction Dc3 is clockwise, and the fourth current direction Dc4 is clockwise.

In some other embodiments, the fourth coil 140 may alternatively be designed to have the fourth current direction Dc4 opposite to the first current direction Dc1. In other words, there are two different current directions among the first current direction Dc1, the second current direction Dc2, the third current direction Dc3, and the fourth current direction Dc4. In one example, one of the first current direction Dc1, the second current direction Dc2, the third current direction Dc3, and the fourth current direction Dc4 are different from the remaining three current directions, or two of the four directions are the same.

Refer to FIG. 19 to FIG. 21. In some embodiments, the multi-receiving wireless charging device 100B further includes a plurality of energy conversion circuits 150, a voltage regulator circuit 160, a plurality of control circuits 170, and a plurality of notification circuits 180. The energy conversion circuits 151 to 153/151 to 154 are electrically connected to coils 110 to 130/110 to 140 in one-to-one correspondence. In other words, a quantity of the energy conversion circuits 150 corresponds to a quantity of coils of the planar induction coil assembly 100A.

Output of each energy conversion circuit 150 is further electrically connected to the voltage regulator circuit 160. The control circuits 171 and 172 are electrically connected to the voltage regulator circuit 160. Input ends of the notification circuits 181 and 182 are electrically connected to the control circuits 171 and 172 respectively. Output ends of the notification circuits 181 and 182 are each electrically connected to at least one of coils 110 to 130/110 to 140.

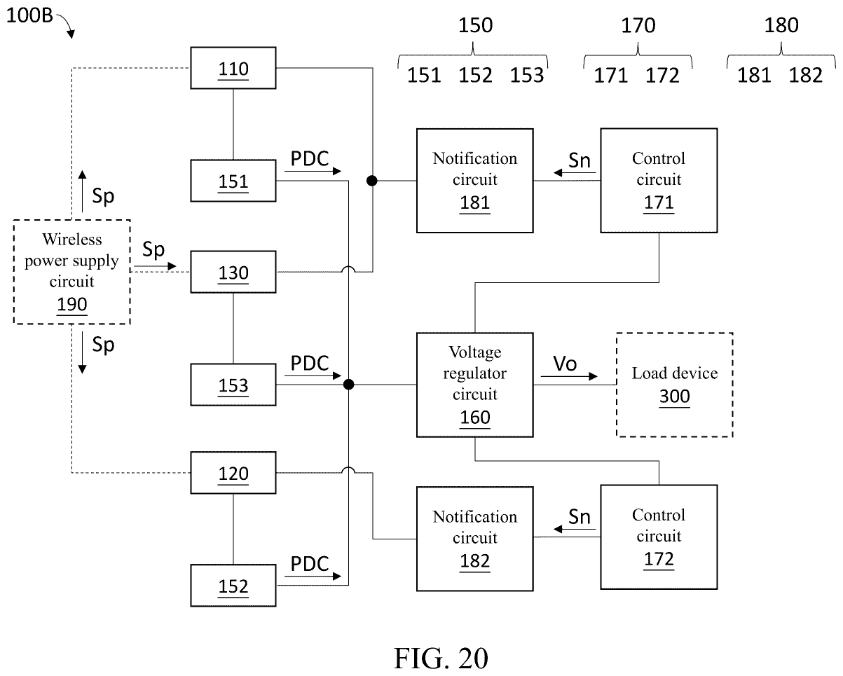

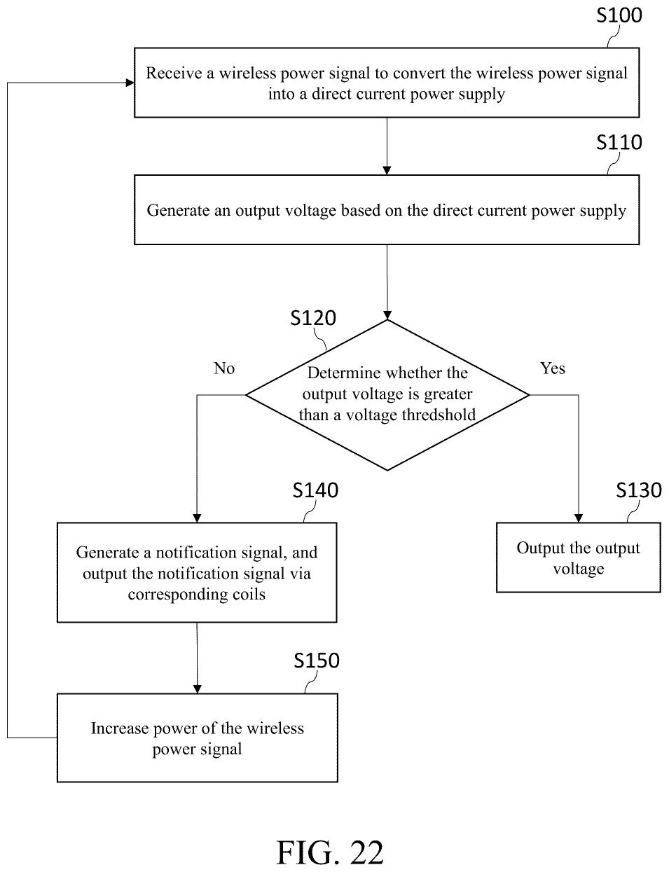

In some embodiments, refer to FIG. 20 and FIG. 22. When the multi-receiving wireless charging device 100B is located within a magnetic field range of a corresponding transmitting end, one or more coils 110 to 130 of the planar induction coil assembly 100A may receive a wireless power signal Sp via an inductive power carrier, and convert the wireless power signal Sp into a direct current power supply PDC via the energy conversion circuits 151 to 153 (step S100).

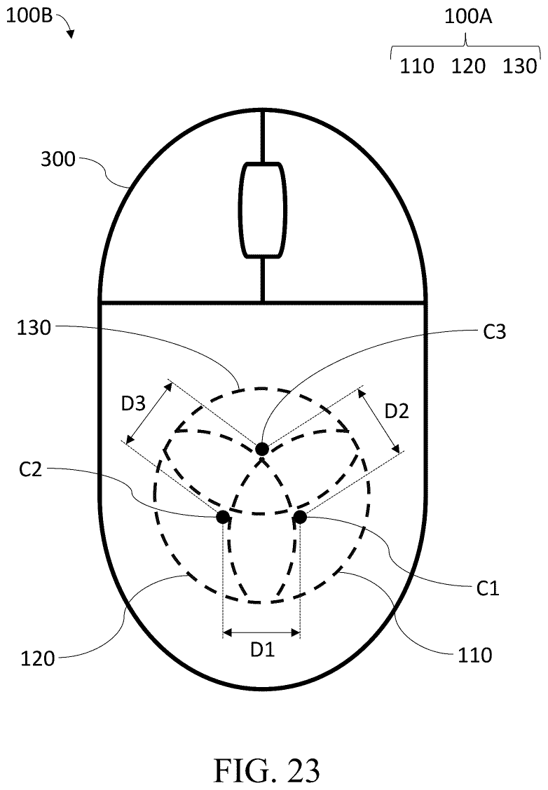

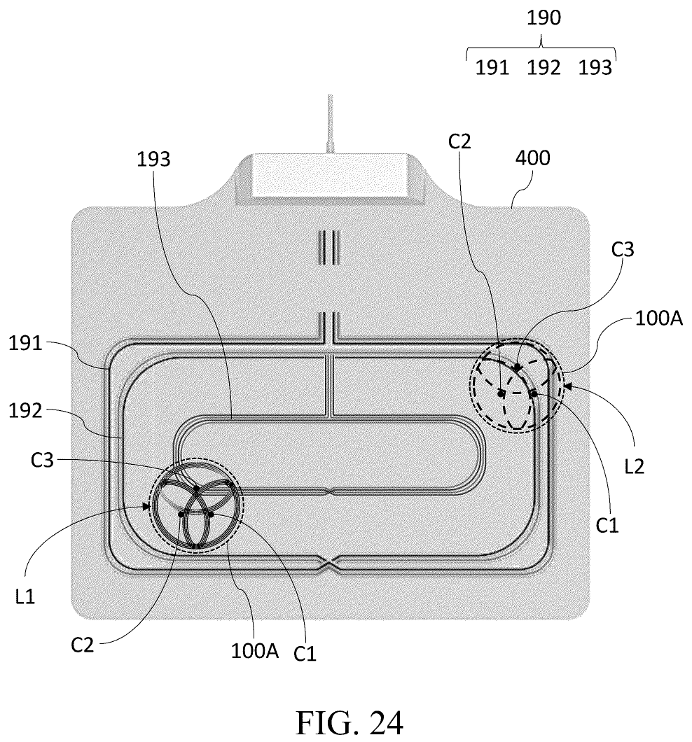

In some embodiments, the multi-receiving wireless charging device 100B may be applied to various types of load devices 300. For example, a load device 300 may be, but not limited to, a wireless mouse, a wireless keyboard, a smartphone, a tablet computer, or a portable game console. Refer to FIG. 23 and FIG. 24. For example, the load device 300 may be a wireless mouse, and the planar induction coil assembly 100A is disposed at the bottom of a shell of the wireless mouse. It should be noted that, for ease of description, only coils of the planar induction coil assembly 100A (for example, the first coil 110, the second coil 120, and the third coil 130) and the load device 300 are shown in FIG. 23. In fact, in some embodiments, all circuits in the multi-receiving wireless charging device 100B are disposed in the load device 300 (not shown).

In some embodiments, the multi-receiving wireless charging device 100B is provided with a transmitting end for charging. A receiving end has a wireless power supply circuit 190, and the wireless power supply circuit 190 has at least one transmitting coil. The transmitting coil can generate and wirelessly transmit, in a form of a power carrier, the wireless power signal Sp. In some embodiments, the transmitting end may be a wireless auxiliary device 400 used with the load device 300. The wireless power supply circuit 190 is disposed in the wireless auxiliary device 400.

Refer to FIG. 23 and FIG. 24. For example, a load device 300 including the multi-receiving wireless charging device 100B (that is, the receiving end) may be a wireless mouse. The planar induction coil assembly 100A is disposed at the bottom of a housing of the wireless mouse. The wireless auxiliary device 400, as the transmitting end, may be a wireless charging pad or a wireless charging mouse pad, and the wireless power supply circuit 190 is disposed in the wireless auxiliary device 400. The wireless power supply circuit 190 has more than one transmitting coils 191 to 193. The transmitting coils 191 to 193 are disposed in a wireless charging pad or a wireless charging mouse pad approximately parallel to a surface of the wireless charging pad or the wireless charging mouse pad. In other words, provided that the multi-receiving wireless charging device 100B (corresponding to the wireless mouse) is disposed in a vertical direction of the wireless power supply circuit 190 (corresponding to the wireless charging pad) (that is, a Z-axis direction as shown in FIG. 24) and moves within an effective power supply range of the wireless power supply circuit 190 (for example, a maximum area range of the wireless charging pad on an XY plane and a maximum area range of the wireless charging pad in the Z-axis direction), the multi-receiving wireless charging device 100B can be charged. In this way, the load device 300 can be charged at a same time when a function of the load device 300 is used, thereby extending service duration of the load device 300.

In some embodiments, the coils 110 to 130/110 to 140 of the planar induction coil assembly 100A receive, by using a magnetic resonance (Magnetic resonance) wireless charging technology, the wireless power signal Sp generated by the wireless power supply circuit 190. In the magnetic resonance wireless charging technology, electrical energy is converted into magnetic energy via a coil, and then the magnetic energy is converted back into the electrical energy via another coil.

Using FIG. 4 and FIG. 5 as examples, in some embodiments, an overlapping region of the first coil 110, the second coil 120, and the third coil 130 includes a plurality of hollow regions A1, A2, A3, and A4. Each coil 110/120/130 induces an electromagnetic field (corresponding to the magnetic energy) passing through corresponding hollow regions of the coils and converts the electromagnetic field into a current (corresponding to the electrical energy). For example, when an electromagnetic field passes through a hollow region A1 overlapped between the first coil 110 and the second coil 120, the first coil 110 and the second coil 120 induce the electromagnetic field and convert the electromagnetic field into a current.

Using FIG. 15 and FIG. 16 as examples, in some embodiments, an overlapping region of the first coil 110, the second coil 120, the third coil 130, and the fourth coil 140 includes a plurality of hollow regions A5, A6, A7, and A8. Each coil 110/120/130/140 induces an electromagnetic field (corresponding to the magnetic energy) passing through corresponding hollow regions of the coils and converts the electromagnetic field into a current (corresponding to the electrical energy). For example, when an electromagnetic field passes through a hollow region A6 overlapped between the first coil 110 and the third coil 130, the first coil 110 and the third coil 130 induce the electromagnetic field and convert the electromagnetic field into a current.

Therefore, the magnetic resonance wireless charging technology is known by a person of ordinary skill in the art, and details are not described herein.

In some embodiments, refer to FIGS. 23 and 24. A minimum distance of a line connecting any two centers of the coils 110 to 130 of the planar induction coil assembly 100A is greater than a wound line distance of each transmitting coil 191/192/193. Using FIG. 23 and FIG. 24 as examples, a distance D1 between the first coil 110 and the second coil 120, a distance D2 between the third coil 130 and the first coil 110, and a distance D3 between the second coil 120 and the third coil 130 are each greater than the wound line distances of the transmitting coils 191 to 193 (that is, a maximum width of a linear segment of the wound line). In this way, the multi-receiving wireless charging device 100B can ensure that at least one of all coils 110 to 130/110 to 140 is not simultaneously located in a vertical direction of the wound line of a same transmitting coil 191/192/193 with the remaining coils.

Refer to FIG. 24. For example, when the planar induction coil assembly 100A moves to a location L1 (which is a bend of the inner transmitting coil 193), only a center C3 of the third coil 130 is located on the transmitting coil 193, and the first coil 110 and the second coil 120 can still receive the wireless power signal Sp transmitted by the transmitting coil 193. When the planar induction coil assembly 100A moves to a location L2, a center C2 of the second coil 120 is not located on the transmitting coil 192. Therefore, even if a center C1 of the first coil 110 and the center C3 of the third coil 130 are both located on the transmitting coil 192, the second coil 120 can still receive the wireless power signal Sp transmitted by the transmitting coil 192.

After step S100, the voltage regulator circuit 160 receives a direct current power supply PDC and generates an output voltage Vo based on the direct current power supply PDC (step S110), and generates, by the control circuits 171 and 172, a notification signal Sn based on the output voltage Vo and a voltage threshold. In some embodiments, the control circuits 171 and 172 determine whether the output voltage Vo is greater than the voltage threshold (step S120). When the output voltage Vo is greater than the voltage threshold, power received by the multi-receiving wireless charging device 100B is sufficient to charge the load device 300. In this case, the control circuits 171 and 172 do not generate a notification signal Sn that notifies the transmitting end to adjust power. The voltage regulator circuit 160 outputs the output voltage Vo to a load circuit of the load device 300 to charge the load device 300 (step S130). When the output voltage Vo is less than or equal to the voltage threshold, it means that the power received by the multi-receiving wireless charging device 100B is not sufficient to charge the load device 300. In this case, the control circuits 171 and 172 may generate the notification signal Sn, and the notification signal Sn is output, by the notification circuits 181 and 182, to the wireless power supply circuit 190 via the corresponding coils 110 to 130 (step S140). For example, in a case that at least one of the coils 110 to 130 of the planar induction coil assembly 100A cannot receive the wireless power signal Sp due to failure or just being located in a charging dead zone, the output voltage Vo is less than or equal to the voltage threshold. In this case, the multi-receiving wireless charging device 100B actively notifies the transmitting end to increase the power, so that the output voltage Vo satisfies power supply needed by the load device 300.

In some embodiments, the voltage threshold may be determined based on power supply needed by an applied load device 300. For example, during producing, a developer can set a voltage threshold based on the power supply needed by the applied load device 300 and write the voltage threshold into the load device 300.

After step S140, when the wireless power supply circuit 190 receives the notification signal Sn via the transmitting coils 191 to 193, the wireless power supply circuit 190 responds to the notification signal Sn to increase power of the wireless power signal Sp transmitted via the transmitting coils 191 to 193 (step S150). In this case, the multi-receiving wireless charging device 100B receives the wireless power signal Sp having large power again to convert the wireless power signal Sp into a direct current power supply PDC (that is, step S100 is performed again) and performs the following steps.

In some embodiments, two coils 110 and 120 having different current directions among the coils 110 to 130 of the planar induction coil assembly 100A are electrically connected to different notification circuits 181 and 182 respectively. For example, based on the foregoing example, the first coil 110 and the second coil 120 have opposite current directions, the first coil 110 is electrically connected to the notification circuit 181, and the second coil 120 is electrically connected to the notification circuit 182.

In some embodiments, the third coil 130 may be electrically connected to the notification circuit 181, or may be electrically connected to the notification circuit 182. For example, based on the foregoing example, the third coil 130 has a same current direction as the first coil 110, and the third coil 130 is electrically connected to the notification circuit 181.

For example, based on the example that the planar induction coil assembly 100A includes three coils 110 to 130, the notification circuit 181 transmits the notification signal Sn to the wireless power supply circuit 190 via the first coil 110 and the third coil 130. The notification circuit 182 transmits the notification signal Sn to the wireless power supply circuit 190 via the second coil 120.

When the first coil 110 has a problem (for example, the first coil cannot transmit a signal with the transmitting coils 191 to 193 normally), the third coil 130 having a same current direction may have a problem. In this case, the multi-receiving wireless charging device 100B can still transmit the signals (that is, the wireless power signal Sp and the notification signal Sn) with the transmitting coils 191 to 193 via the second coil 120 having an opposite current direction. In other words, when the first coil 110 has a problem, the first coil 110 cannot receive the wireless power signal Sp. Likewise, the first coil 110 cannot transmit the notification signal Sn to the wireless power supply circuit 190. Because the first coil 110 cannot receive the wireless power signal Sp, total power of the wireless power signal Sp received by the planar induction coil assembly 100A decreases, and then the output voltage Vo generated by the voltage regulator circuit 160 also decreases correspondingly (that is, less than or equal to the voltage threshold). In this case, the control circuits 171 and 172 each generate a notification signal Sn to the notification circuits 181 and 182. The notification circuit 182 transmits the notification signal Sn to the wireless power supply circuit 190 via the second coil 120. In this way, even if the multi-receiving wireless charging device 100B cannot transmit, by the notification circuit 181, the notification signal Sn via the first coil 110 and the third coil 130, the multi-receiving wireless charging device 100B can still transmit the notification signal Sn through the notification circuit 182 via the second coil 120.

In some embodiments, the energy conversion circuit 150 and the voltage regulator circuit 160 may be hardware elements having a power conversion function, for example, but not limited to a DC-DC converter (DC-DC converter), an AC-DC converter (AC-DC converter), an AC-AC converter (AC-AC converter), a rectifier (Rectifier), an inverter (Inverter), a voltage stabilizer (Voltage stabilizer), or a voltage regulator (Voltage regulator).

In some embodiments, the control circuit 170 may be a hardware element having a control function and a comparison function, for example, but not limited to a central processing unit (Central Processing Unit, CPU), a microprocessor (Microprocessor), a microcontroller (Microcontroller), a digital signal processor (Digital Signal Processor, DSP), a programmable logic controller (Programmable Logic Controller, PLC), a complex programmable logic device (Complex Programmable Logic Device, CPLD), a field programmable gate array (Field Programmable Gate Array, FPGA), an application specific integrated circuit (Application Specific Integrated Circuit, ASIC), or a finite-state machine (Finite-State Machine, FSM). In other embodiments, the control circuit 170 may be implemented by an integrated circuit (Integrated Circuit, IC), a system-on-chip (System-On-Chip, SoC), or any analog and/or digital circuit that operates a signal based on an operating instruction.

In some embodiments, the voltage regulator circuit 160 and the control circuit 170 may be integrated into a single hardware element, for example, but not limited to a voltage regulator control chip having voltage regulation and control functions.

In some embodiments, the notification circuit 180 may be a hardware element having a wireless communication function, for example, but not limited to a radio transmitter, a wireless fidelity (Wi-Fi) chip, a Bluetooth chip, or a near field communication (Near Field Communication, NFC) chip.

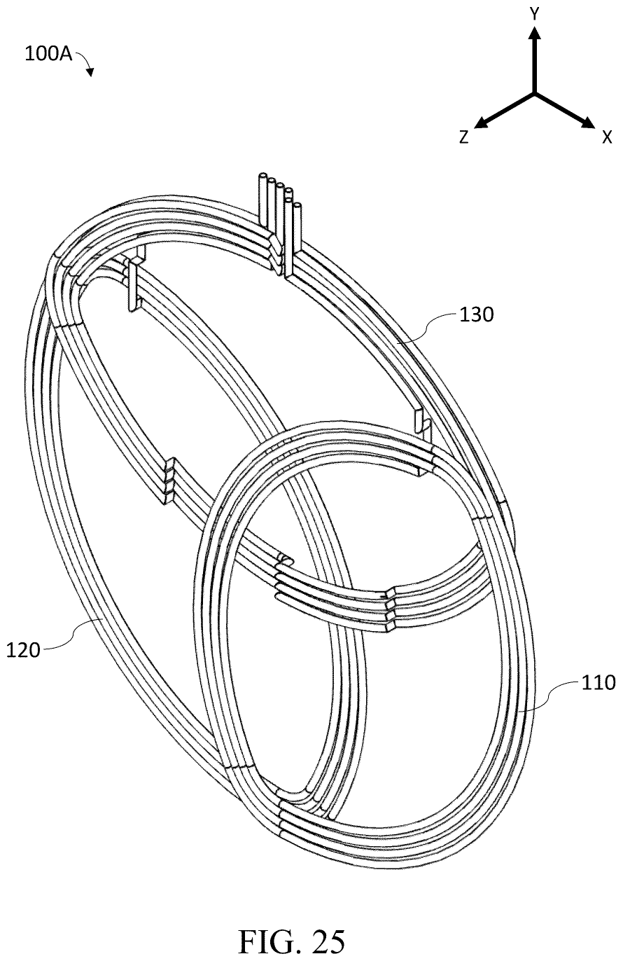

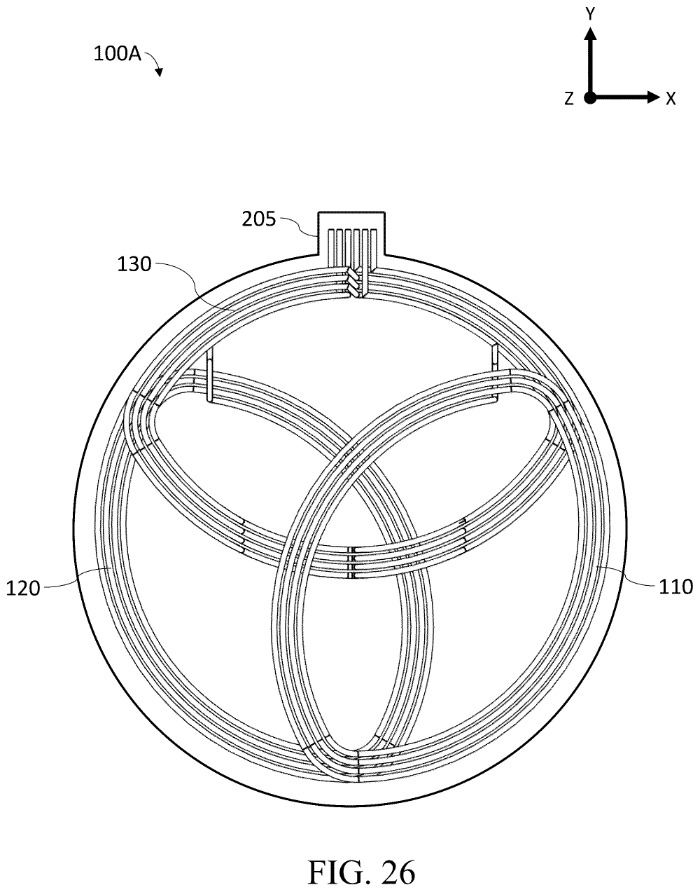

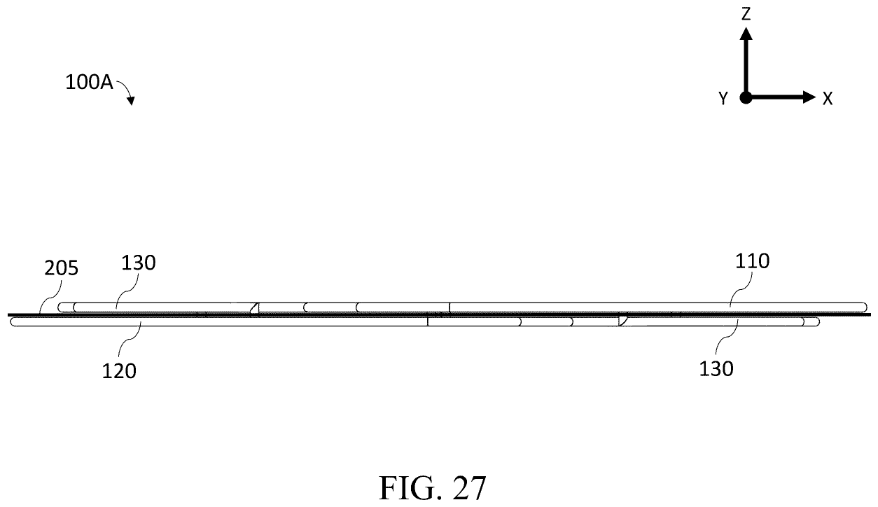

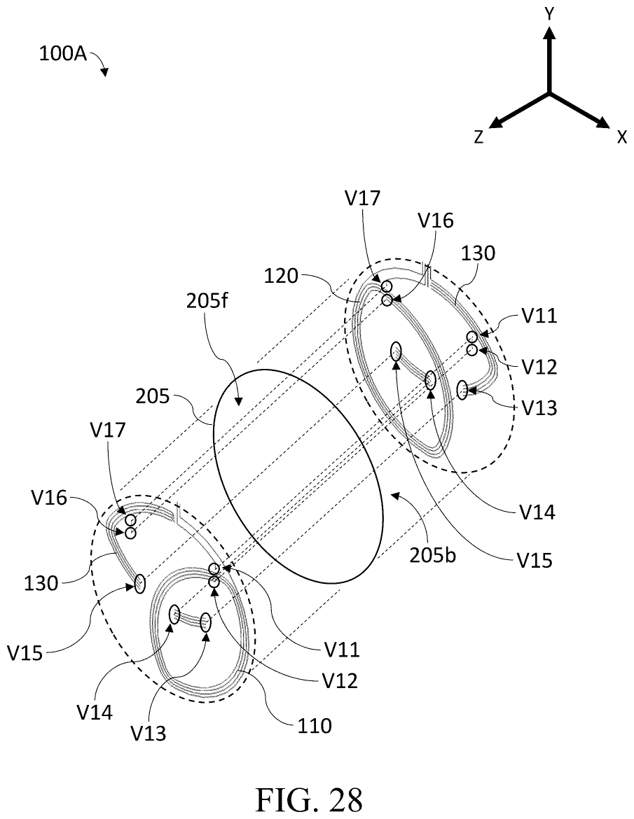

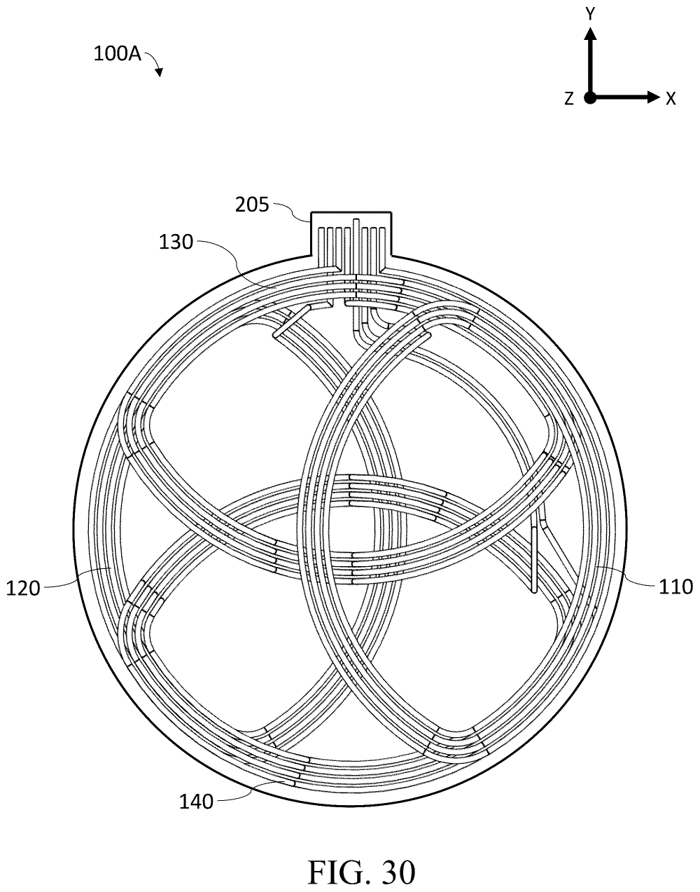

Refer to FIG. 25 to FIG. 32. In some embodiments, the planar induction coil assembly 100A includes only a single-layer insulating substrate (corresponding to an insulating layer 205). As shown in FIG. 25 to FIG. 28, in some embodiments, the planar induction coil assembly 100A includes three coils 110, 120, and 130. The coils 110/120/130 are each a spiral winding having four turns. Using FIG. 27 and FIG. 28 as examples, the four-turn spiral winding in the first coil 110 is located on a front surface 205f of the insulating layer 205. The four-turn spiral winding in the second coil 120 is located on a back surface 205b of the insulating layer 205. A part of line segments of the four-turn spiral winding in the third coil 130 (that is, a first line segment group of the third coil 130) is located on the front surface 205f of the insulating layer 205. The remaining part of segments of the four-turn spiral winding in the third coil 130 (that is, a second line segment group of the third coil 130) is located on the back surface 205b of the insulating layer 205.

Therefore, a plurality of pilot holes V11 to V17 penetrate the insulating layer 205 and are electrically connected to the first line segment group of the third coil 130 and the second line segment group of the third coil 130. In other words, the first line segment group of the third coil 130 on the front surface 205f of the insulating layer 205 is electrically connected to the second line segment group of the third coil 130 on the back surface 205b of the insulating layer 205 via the pilot holes V11 to V17 to form all turns of the third coil 130.

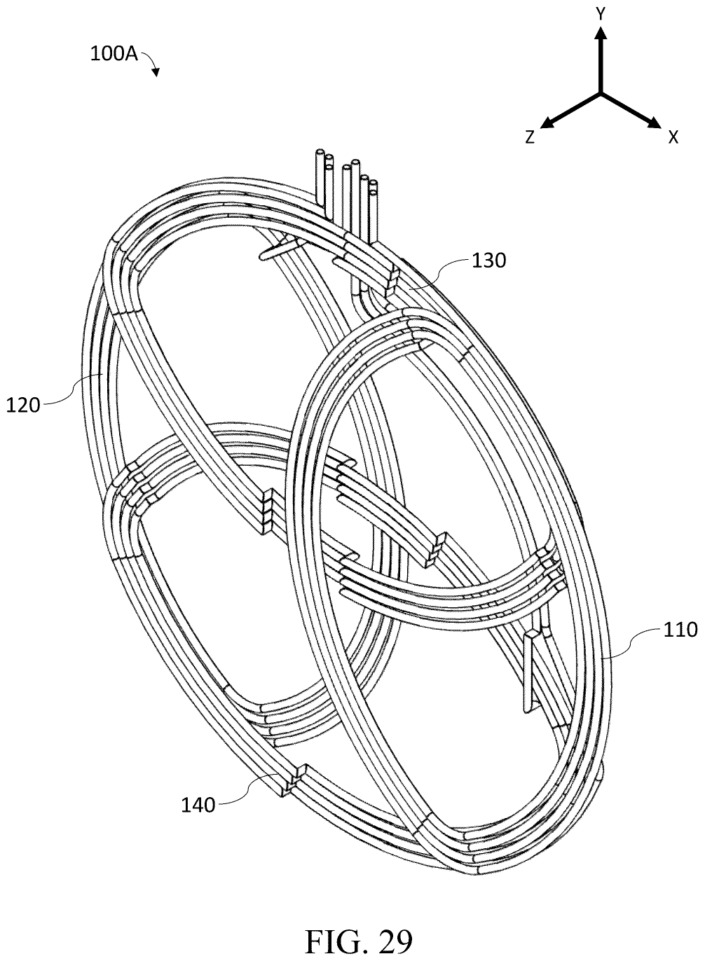

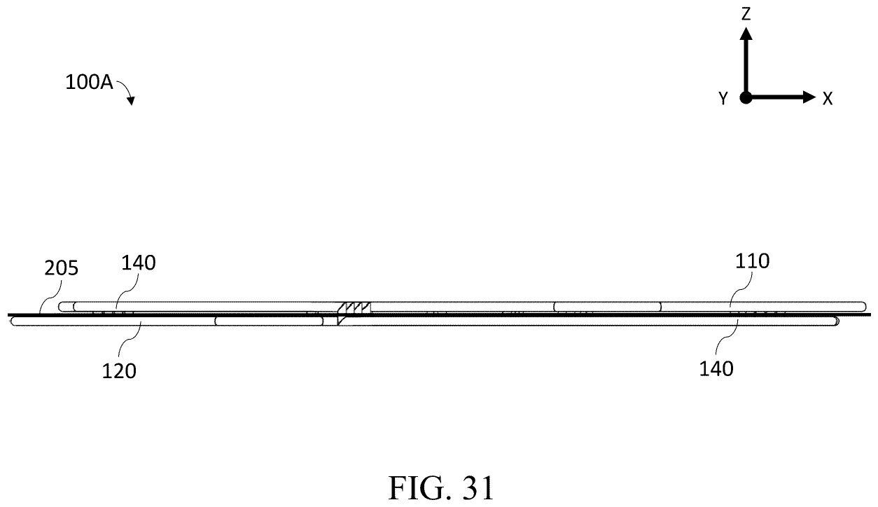

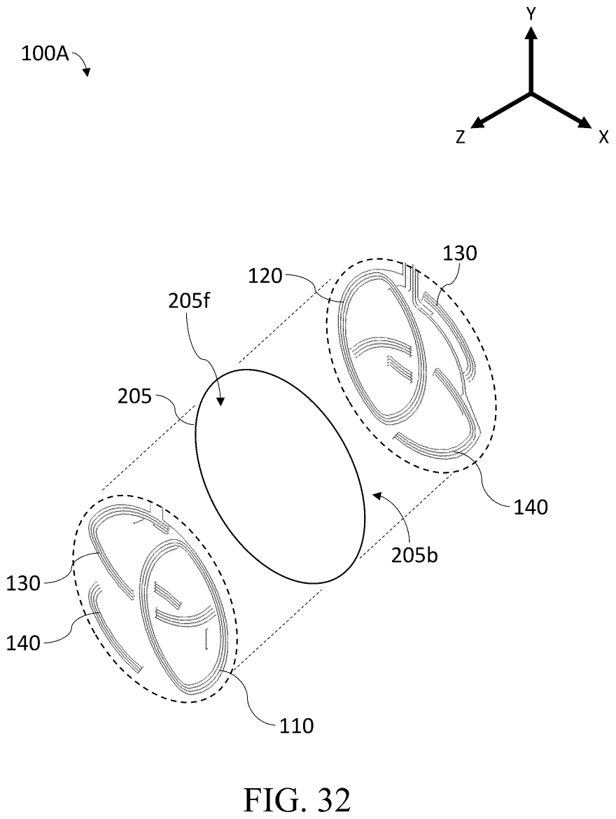

As shown in FIG. 29 to FIG. 32, in some embodiments, the planar induction coil assembly 100A includes four coils 110, 120, 130, and 140. The coils 110/120/130/140 are each a spiral winding having four turns. Using FIG. 31 and FIG. 32 as examples, the four-turn spiral winding in the first coil 110 is located on a front surface 205f of an insulating layer 205. The four-turn spiral winding in the second coil 120 is located on a back surface 205b of the insulating layer 205. A part of line segments of the four-turn spiral winding in the third coil 130 (that is, a first line segment group of the third coil 130) is located on the front surface 205f of the insulating layer 205. The remaining part of line segments of the four-turn spiral winding in the third coil 130 (that is, a second line segment group of the third coil 130) is located on the back surface 205b of the insulating layer 205. A part of line segments of the four-turn spiral winding in the fourth coil 140 (that is, a first line segment group of the fourth coil 140) is located on the front surface 205f of the insulating layer 205. The remaining part of line segments of the four-turn spiral winding in the fourth coil 140 (that is, a second segment group of the fourth coil 140) is located on the back surface 205b of the insulating layer 205.

Therefore, a plurality of pilot holes (not shown) penetrate the insulating layer 205 and are electrically connected to the first line segment group of the third coil 130 and the second line segment group of the third coil 130. A plurality of another pilot holes (not shown) penetrate the insulating layer 205 and are electrically connected to the first line segment group of the fourth coil 140 and the second line segment group of the fourth coil 140. In other words, the first line segment group of the third coil 130 on the front surface 205f of the insulating layer 205 is electrically connected to the second line segment group of the third coil 130 on the back surface 205b of the insulating layer 205 via the plurality of pilot holes to form all turns of the third coil 130. The first line segment group of the fourth coil 140 on the front surface 205f of the insulating layer 205 is electrically connected to the second line segment group of the fourth coil 140 on the back surface 205b of the insulating layer 205 via the plurality of pilot holes to form all turns of the fourth coil 140.

It should be noted that, in some embodiments, the planar induction coil assembly 100A in each embodiment shown in FIG. 25 to FIG. 32 can also be applied to the multi-receiving wireless charging device 100B.

In summary, according to any embodiment, the planar induction coil assembly 100A or the multi-receiving wireless charging device 100B having a specific layout of a plurality of coils 110 to 130/110 to 140 is applied to a load device 300. This can ensure that the load device 300 can be charged when at least one of the plurality of coils 110 to 130/110 to 140 located on the wireless power supply circuit 190 does not fall into the charging dead zone of the wireless power supply circuit 190. In some embodiments, the multi-receiving wireless charging device 100B can also notify, when the output voltage Vo generated by the multi-receiving wireless charging device 100B is insufficient, the wireless power supply circuit 190 via at least one of the plurality of coils 110 to 130/110 to 140 to increase power of the wireless power signal Sp generated by the wireless power supply circuit to increase the output voltage Vo generated by the multi-receiving wireless charging device 100B, thereby improving charging efficiency of the multi-receiving wireless charging device 100B.

Although the present application has been described in considerable detail with reference to certain preferred embodiments thereof, the disclosure is not for limiting the scope of the application. Persons having ordinary skill in the art may make various modifications and changes without departing from the scope and spirit of the application. Therefore, the scope of the appended claims should not be limited to the description of the preferred embodiments described above.

What is claimed is:

1. A planar induction coil assembly, comprising:
a first coil, having a first spiral direction from outside to inside;
a second coil, having a second spiral direction, wherein the first spiral direction is opposite to the second spiral direction; and
a third coil, wherein
the first coil, the second coil, and the third coil are electrically isolated from each other, and a vertical projection of each of the first coil, the second coil, and the third coil partially overlaps the vertical projection of at least one of the remaining two coils.

2. The planar induction coil assembly according to claim 1, wherein a contour of each coil has a first arc, and the first arc of the contour of the first coil, the first arc of the contour of the second coil, and the first arc of the contour of the third coil together form an oblate, an oval, or a circular outer contour having an area larger than the contour of each coil.

3. The planar induction coil assembly according to claim 2, wherein the first coil, the second coil, and the third coil each have the oblate contour.

4. The planar induction coil assembly according to claim 2, wherein the first coil is symmetrically arranged with the second coil, and the first coil is rotated by 60 degrees relative to the third coil.

5. The planar induction coil assembly according to claim 1, further comprising a multi-layer insulating substrate, wherein the first coil, the second coil, and the third coil are arranged on the multi-layer insulating substrate, and the first coil and the second coil are located on different layers of the multi-layer insulating substrate; and
the multi-layer insulating substrate comprises three surfaces isolated from each other by an insulating substrate, and the first coil, the second coil, and the third coil are respectively located on the three surfaces.

6. The planar induction coil assembly according to claim 5, wherein the third coil comprises:
a first line segment group, located on a same layer of the multi-layer insulating substrate as the first coil and electrically isolated from the first coil;
a second line segment group, located on a same layer of the multi-layer insulating substrate as the second coil and electrically isolated from the second coil; and
a plurality of pilot holes, penetrating at least one layer of the multi-layer insulating substrate and electrically connected to the first line segment group and the second line segment group.

7. The planar induction coil assembly according to claim 1, further comprising:
a fourth coil, electrically isolated from the first coil, the second coil, and the third coil, wherein
a vertical projection of each of the first coil, the second coil, the third coil, and the fourth coil partially overlaps the vertical projections of at least two of the remaining three coils.

8. The planar induction coil assembly according to claim 7, wherein a contour of each coil comprises a first arc and a second arc, and the first arc of the contour of the first coil, the first arc of the contour of the second coil, the first arc of the contour of the third coil, and the first arc of the contour of the fourth coil together form an oblate, an oval, or a circular outer contour having an area larger than the contour of each coil.

9. A multi-receiving wireless charging device, comprising:
a first coil;
a second coil, wherein the first coil and the second coil have opposite current directions; and
a third coil, wherein
the first coil, the second coil, and the third coil are electrically isolated from each other, and vertical projections of the first coil, the second coil, and the third coil partially overlap.

10. The multi-receiving wireless charging device according to claim 9, further comprising:
a multi-layer insulating substrate, wherein the first coil, the second coil, and the third coil are arranged on the multi-layer insulating substrate, and the first coil and the second coil are located on different layers of the multi-layer insulating substrate.

11. The multi-receiving wireless charging device according to claim 10, wherein the multi-layer insulating substrate comprises three surfaces isolated from each other by an insulating substrate, and the first coil, the second coil, and the third coil are respectively located on the three surfaces.

12. The multi-receiving wireless charging device according to claim 10, wherein the third coil comprises:
a first line segment group, located on a same layer of the multi-layer insulating substrate as the first coil and electrically isolated from the first coil;
a second line segment group, located on a same layer of the multi-layer insulating substrate as the second coil and electrically isolated from the second coil; and
a plurality of pilot holes, penetrating at least one layer of the multi-layer insulating substrate and electrically connected to the first line segment group and the second line segment group.

13. The multi-receiving wireless charging device according to claim 9, further comprising:
a plurality of energy conversion circuits, wherein the energy conversion circuits are electrically connected to the first coil, the second coil, and the third coil in one-to-one correspondence to receive a wireless power signal to convert the wireless power signal into a direct current power supply;
a voltage regulator circuit, electrically connected to the plurality of energy conversion circuits to generate an output voltage based on the direct current power supply;
a plurality of control circuits, electrically connected to the voltage regulator circuit to generate a notification signal based on the output voltage and a voltage threshold; and
a plurality of notification circuits, electrically connected to the control circuits, wherein each notification circuit is electrically connected to at least one of the first coil, the second coil, and the third coil to wirelessly output the notification signal via the electrically connected coil, wherein
the first coil and the second coil are electrically connected to different notification circuits.

14. The multi-receiving wireless charging device according to claim 13, wherein the wireless power signal is generated by a wireless power supply circuit, and the wireless power supply circuit is further configured to receive the notification signal to increase power of the wireless power signal; and
the wireless power supply circuit has at least one transmitting coil, and a distance of a line connecting any two centers of the first coil, the second coil, and the third coil is greater than a wound line distance of each transmitting coil.

15. The multi-receiving wireless charging device according to claim 9, wherein an overlapping region of the first coil, the second coil, and the third coil comprises hollow regions.

16. The multi-receiving wireless charging device according to claim 9, wherein the first coil, the second coil, and the third coil together form a circular or an oblate outer contour having an area larger than each coil.

17. The multi-receiving wireless charging device according to claim 9, further comprising:
a fourth coil, wherein
the first coil, the second coil, the third coil, and the fourth coil are electrically isolated from each other, and vertical projections of the first coil, the second coil, the third coil, and the fourth coil partially overlap.

18. The multi-receiving wireless charging device according to claim 17, further comprising:
a multi-layer insulating substrate, comprising four surfaces isolated from each other by an insulating substrate, and the first coil, the second coil, the third coil, and the fourth coil are respectively located on the four surfaces.

19. The multi-receiving wireless charging device according to claim 17, wherein an overlapping region of the first coil, the second coil, the third coil, and the fourth coil comprises hollow regions.

20. The multi-receiving wireless charging device according to claim 17, wherein the first coil, the second coil, the third coil, and the fourth coil together form a circular or an oblate outer contour having an area larger than each coil.
